(19) United States
(12) Patent Application Publication
(10) Pub. No.: US 2016/0055306 A1
(43) Pub. Date: Feb. 25, 2016

(54) USER CONDITION CHECKING SYSTEM, USER CONDITION CHECKING METHOD, COMMUNICATION TERMINAL DEVICE, USER CONDITION NOTIFICATION METHOD, AND COMPUTER PROGRAM

(71) Applicant: SHARP CORPORATION, Osaka-shi, Osaka (JP)

(72) Inventors: Tomohiko OZEKI, Osaka-shi (JP); Daiki OGASAWARA, Osaka-shi (JP)

(73) Assignee: SHARP CORPORATION, Osaka-shi, Osaka (JP)

(21) Appl. No.: 14/780,866

(22) PCT Filed: Mar. 26, 2014
(86) PCT No.: PCT/JP2014/058525

§ 371 Date: Sep. 28, 2015

(30) Foreign Application Priority Data
Mar. 29, 2013 (JP) 2013-071886

(51) Int. Cl. G06F 19/00; H04L 12/58; H04N 5/232

(52) U.S. Cl. CPC G06F 19/3418; H04N 5/23206; H04L 51/16

(57) ABSTRACT

[Object] To make it possible to remotely check a condition of a monitored person in detail without using monitoring sensors.

[Solution] In a user condition checking system 1, a connection terminal device 30 is connected to a television device 10 operated by a user, so as to enable communication with a server device 2. The communication terminal device 3 acquires a user operation state output from the television device 10. Upon acquisition of the user operation state, the communication terminal device 30 outputs, to the television device 10, screen information corresponding to a question screen or the like to be displayed on the television device 10. The communication terminal device 30 acquires a user's answering state for the displayed question screen or the like and transmits the user's answering state to the server device 2. In this way, the server device 2 can check the condition of the monitored person in detail.

### TECHNICAL FIELD

The present invention relates to a user condition checking system, a user condition checking method, a communication terminal device, a user condition notification method, and a computer program that make it possible to remotely check the condition of a user by causing a state of a user operation on a display device which is used by the user to be transmitted to a server device via a communication terminal device.

### BACKGROUND ART

There have been many systems (such as systems of watch-over services) that make it possible to remotely check the condition of a person or persons who live by themselves. PTL 1 discloses a system that includes a plurality of monitoring sensors installed in a house of a target person to be checked on and that makes it possible to remotely check and monitor the condition of the target person via a communication network. In addition, in PTL 2, usage states of various electrical appliances used in a house of a target person to be checked on are transmitted to a home terminal installed in the house. The home terminal accumulates therein data on the usage states that has been transmitted thereto and transmits the accumulated data to a server so as to allow the server to determine whether any change has occurred in the lifestyle of the target person.

### CITATION LIST

### Patent Literature

PTL 1: Japanese Unexamined Patent Application Publication No. 2002-324291

PTL 2: Japanese Unexamined Patent Application Publication No. 2002-92767

### SUMMARY OF INVENTION

### Technical Problem

The aforementioned system according to PTL 1 requires many sensors of various types, and these sensors need to be installed at suitable locations in the house. Moreover, sensors typically do not have a communication function. Even in the case where the sensors are attached to appliances and equipment (e.g., an electric light, a refrigerator, and a toilet) used by the user, such appliances and equipment typically do not have a communication function. Therefore, the sensors need to be connected to a communication device so as to enable transmission of detection results acquired by the sensors. For these reasons, the effort and cost are required for installing many sensors and for transmitting detection results, making the construction of the remote monitoring system of the related art costly. This consequently makes it difficult to readily introduce such a system to ordinary households.

Moreover, detection results acquired by respective sensors are typically binary results merely indicating whether or not detection is successful. With such detection results, it is impossible to remotely check a change in a user's condition, such as a user's mental and health condition in detail. Furthermore, it is desired by those in charge of monitoring to immediately check whether or not the user is alive at a certain point of monitoring, such as at the change of the date.

In PTL 2, on the other hand, connection of the home terminal to a display device (such as a television device, a display device for personal computers, a digital photoframe, or a tablet) is not intended. Accordingly, the server is not capable of checking the condition of a user on the basis of a state of a user operation on the display device. Although display devices are capable of presenting various kinds of information to a user through display screens, the systems of watch-over services of the related art described in PTL 1 and PTL 2 do not ask the user about their condition through the display screen. Therefore, the display function of display devices is not effectively used in terms of inquiring about the user's condition.

The present invention has been made in the light of the situations described above, an object of the present invention is to provide a user condition checking system, a user condition checking method, a communication terminal device, a user condition notification method, and a computer program that make it possible, without using various types of sensors, to check the condition of a user in more detail than that achieved with the related art, by connecting a display device installed in a house to a communication terminal device with or without a cable and by displaying a question on the display device to inquire about the condition of the user.

In addition, another object of the present invention is to provide a user condition checking system, a user condition checking method, a communication terminal device, a user condition notification method, and a computer program that make it possible to immediately check whether or not the user is alive by displaying, on the display device, antecedent information that permits a user operation prior to the question.

### Solution to Problem

To this end, a user condition checking system according to the present invention is a user condition checking system enabling a server device to remotely check a condition of a user by causing a communication terminal device that is connectable to an external display device operated by the user to transmit, to the server device, information based on a state of a user operation on the external display device. In such a system, the communication terminal device includes means for performing a process of transmitting, to the server device, power-on information indicating that there has been a power-on operation, in a case where information indicating that there has been a power-on operation is acquired from the external display device; means for outputting, to the external display device, question screen information containing a question that can be answered by a selection operation, in response to the acquisition of the information indicating that there has been a power-on operation; and means for performing a process of transmitting, to the server device, answering state information indicating a question answering state of the user, and the server device includes means for performing a process of storing the power-on information in association with a reception date-and-time of the power-on information in a case of receipt of the power-on information; and means for performing a process of storing the answering state information in association with a reception date-and-time of the answering state information in a case of receipt of the answering state information.

In addition, in the user condition checking system according to the present invention, the communication terminal device stores a time threshold, and is configured to transmit, to the server device, answering state information indicating that there is no answer to the question, upon a period from the output of the question screen information to the external display device exceeding the time threshold without acquiring any answer to the question from the external display device.

Further, in the user condition checking system according to the present invention, the communication terminal device further includes means for outputting, to the external display device, a display switching instruction so as to cause the external display device to switch a displayed screen to a screen containing the question, in a case where the information indicating that there has been a power-on operation is acquired from the external display device.

Furthermore, in the user condition checking system according to the present invention, the external display device is a television device, and the communication terminal device further includes means for outputting, to the external display device, screen information that permits an end operation, in a case where an answer to the question is acquired from the external display device; and means for outputting, to the external display device, a display switching instruction so as to cause the displayed screen to be switched to a screen of a received television broadcast, in a case where information indicating that there has been an end operation is acquired from the external display device.

In the user condition checking system according to the present invention, the communication terminal device further includes means for outputting, to the external display device, screen information that permits an end operation, in a case where an answer to the question is acquired from the external display device; and means for outputting, to the external display device, proper screen information containing content uniquely provided by the communication terminal device, in a case where information indicating that there has been an end operation is acquired from the external display device.

In addition, in the user condition checking system according to the present invention, the external display device is a television device, and the communication terminal device stores a time threshold, and further includes means for outputting, to the external display device, a display switching instruction so as to cause the displayed screen to be switched to a screen of a received television broadcast, upon a period from the output of the question screen information to the external display device exceeding the time threshold without acquiring any answer to the question from the external display device.

Further, in the user condition checking system according to the present invention, the communication terminal device outputs, to the external display device, a display switching instruction so as to cause the screen displayed on the external display device to be switched again to the screen containing the question, in a case where a certain period has elapsed from the output of the display switching instruction to the external display device so as to cause the displayed screen to be switched to the screen of the received television broadcast.

Furthermore, in the user condition checking system according to the present invention, the external display device is a television device, and the communication terminal device stores a time threshold and a number-of-times threshold, further includes means for outputting, to the external display device, a first display switching instruction so as to cause the displayed screen to be switched to a screen of a received television broadcast, upon a period from the output of the question screen information to the external display device exceeding the time threshold without acquiring any answer to the question from the external display device; and means for outputting, to the external display device, a second display switching instruction so as to cause the screen displayed on the external display device to be switched again to the screen containing the question, in a case where a certain period has elapsed from the output of the first display switching instruction to the external display device, is configured to sequentially repeat output of the first display switching instruction and output of the second display switching instruction unless an answer to the question re-displayed on the external display device is acquired, and is configured to perform a process of transmitting, to the server device, a notification indicating that an unusual situation has occurred to the user in a case where the number of times of repetition has exceeded the number-of-times threshold.

In the user condition checking system according to the present invention, the communication terminal device further includes antecedent output means for outputting, to the external display device, antecedent information that permits a user operation prior to the question screen information, in a case where the information indicating that there has been a power-on operation is acquired from the external display device, and is configured to output the question screen information to the external display device in a case where information indicating that there has been a user operation on the antecedent information is acquired from the external display device.

In the user condition checking system according to the present invention, the communication terminal device further includes means for performing a process of transmitting, to the server device, a notification indicating that there has been a user operation on the antecedent information, in a case where the information indicating that there has been a user operation on the antecedent information is acquired from the external display device.

In the user condition checking system according to the present invention, the communication terminal device stores a time reference, and further includes means for performing a process of transmitting, to the server device, a notification indicating that there is no user operation, upon a period from the output of the antecedent information exceeding the time reference without acquiring information indicating that there has been a user operation on the antecedent information from the external display device.

In addition, in the user condition checking system according to the present invention, the server device stores a question, and further includes means for performing a process of reading the stored question and transmitting the question to the communication terminal device in a case of receipt of the power-on information, and the communication terminal device is configured to output question screen information containing the received question to the external display device.

A user condition checking method according to the present invention is a user condition checking method enabling a server device to remotely check a condition of a user by causing a communication terminal device that is connectable to an external display device operated by the user to transmit, to the server device, information based on a state of a user operation on the external display device. The user condition checking method includes a step of performing, by the communication terminal device, a process of transmitting, to the server device, power-on information indicating that there has been a power-on operation, in a case where information indicating that there has been a power-on operation is acquired from the external display device; a step of outputting, by the communication terminal device, to the external display device, question screen information containing a question that can be answered by a selection operation, in response to the acquisition of the information indicating that there has been a power-on operation; a step of performing, by the communication terminal device, a process of transmitting, to the server device, answering state information indicating a question answering state of the user; a step of performing, by the server device, a process of storing the power-on information in association with a reception date-and-time of the power-on information in a case of receipt of the power-on information; and a step of performing, by the server device, a process of storing the answering state information in association with a reception date-and-time of the answering state information in a case of receipt of the answering state information.

A communication terminal device according to the present invention is a communication terminal device that is connectable to an external display device operated by a user and that transmits, to an external server device, information based on a state of a user operation on the external display device. The communication terminal device includes means for performing a process of transmitting, to the server device, power-on information indicating that there has been a power-on operation, in a case where information indicating that there has been a power-on operation is acquired from the external display device; means for outputting, to the external display device, question screen information containing a question that can be answered by a selection operation, in response to the acquisition of the information indicating that there has been a power-on operation; and means for performing a process of transmitting, to the external server device, answering state information indicating a question answering state of the user.

In addition, in the communication terminal device according to the present invention, the external display device is a television device, and the communication terminal device further includes means for outputting, to the external display device, screen information that permits an end operation, in a case where an answer to the question is acquired from the external display device; and means for outputting, to the external display device, a display switching instruction so as to cause a displayed screen to be switched to a screen of a received television broadcast, in a case where information indicating that there has been an end operation is acquired from the external display device.

Further, the communication terminal device according to the present invention further includes means for outputting, to the external display device, screen information that permits an end operation, in a case where an answer to the question is acquired from the external display device; and means for outputting, to the external display device, proper screen information containing content uniquely provided by the communication terminal device, in a case where information indicating that there has been an end operation is acquired from the external display device.

Furthermore, in the communication terminal device according to the present invention, the external display device is a television device, and the communication terminal device stores a time threshold, and further includes means for outputting, to the external display device, a display switching instruction so as to cause the displayed screen to be switched to a screen of a received television broadcast, upon a period from the output of the question screen information to the external display device exceeding the time threshold without acquiring any answer to the question from the external display device.

In the communication terminal device according to the present invention, the external display device is a television device, and the communication terminal device stores a time threshold and a number-of-times threshold, further includes means for outputting, to the external display device, a first display switching instruction so as to cause the displayed screen to be switched to a screen of a received television broadcast, upon a period from the output of the question screen information to the external display device exceeding the time threshold without acquiring any answer to the question from the external display device; and means for outputting, to the external display device, a second display switching instruction so as to cause the screen displayed on the external display device to be switched again to the screen containing the question, in a case where a certain period has elapsed from the output of the first display switching instruction to the external display device, is configured to sequentially repeat output of the first display switching instruction and output of the second display switching instruction unless an answer to the question re-displayed on the external display device is acquired, and is configured to perform a process of transmitting, to the external server device, a notification indicating that an unusual situation has occurred to the user, in a case where the number of times of repetition has exceeded the number-of-times threshold.

The communication terminal device according to the present invention further includes antecedent output means for outputting, to the external display device, antecedent information that permits a user operation prior to the question screen information, in a case where the information indicating that there has been a power-on operation is acquired from the external display device, and the communication terminal device is configured to output the question screen information to the external display device in a case where information indicating that there has been a user operation on the antecedent information is acquired from the external display device.

In addition, the communication terminal device according to the present invention further includes means for receiving a question that is transmitted from the external server device, and the communication terminal device is configured to output, to the external display device, question screen information containing the received question in a case of receipt of the question.

A user condition notification method according to the present invention is a user condition notification method causing a communication terminal device that is connectable to an external display device operated by a user to transmit, to an external server device, information based on a state of a user operation on the external display device. The user condition notification method includes a step of performing, by the communication terminal device, a process of transmitting, to the server device, power-on information indicating that there has been a power-on operation, in a case where information indicating that there has been a power-on operation is acquired from the external display device; a step of outputting, by the communication terminal device, to the external display device, question screen information containing a question that can be answered by a selection operation, in response to the acquisition of the information indicating that there has been a power-on operation; and a step of performing, by the communication terminal device, a process of transmitting, to the external server device, answering state information indicating a question answering state of the user.

A computer program according to the present invention is a computer program causing a computer, which is connectable to an external display device operated by a user and which includes communication means capable of communicating with an external server device, to perform a process of transmitting, to the external server device via the communication means, information based on a state of a user operation on the external display device. The computer program causes the computer to function as means for performing a process of transmitting, to the server device by using the communication means, power-on information indicating that there has been a power-on operation, in a case where information indicating that there has been a power-on operation is acquired from the external display device; means for performing a process of outputting, to the external display device, question screen information containing a question that can be answered by a selection operation, in response to the acquisition of the information indicating that there has been a power-on operation; and means for performing a process of transmitting, to the external server device by using the communication means, answering state information indicating a question answering state of the user.

In the present invention, upon acquiring information indicating that there has been a power-on operation from an external display device, a communication terminal device transmits power-on information to a server device. The server device stores the power-on information together with a reception date-and-time. This configuration allows the server device to automatically grasp that the user is at least able to perform a power-on operation together with the date and time of the operation. Further, the communication terminal device also transmits answering state information indicating a question answering state of the user concerning a question contained in question screen information output by the communication terminal device. The server device stores the answering state information together with a reception date-and-time. This configuration allows the server device to grasp the condition of the user in more detail. As a result, the present invention can simplify the structure of the system because the above-described configurations allow the condition of the user to be remotely grasped based on a power-on operation performed on the external display device by the user and the question answering state, without using various sensors. In addition, since a question is displayed on the display device, the display function of the display device is effectively used in the watch-over service.

A question that can be answered by a selection operation is output in response to acquisition of the information indicating that there has been a power-on operation. The present invention encompasses both the cases where the question is output directly and indirectly in response to acquisition of the information indicating that there has been a power-on operation. The case where the question is output indirectly in response to the information indicates the case where another processing is performed or exists between acquisition of the information indicating that there has been a power-on operation and output of the question (the term “in response to” used in the present invention includes both the meanings of directly and indirectly, as for contents other than the above-described one). In addition, the question may have content that inquires the user about their feeling or physical condition. Such content is preferable because the user's feeling or physical condition can be checked remotely. In addition, the number of questions contained in the question screen information is not specified particularly. Both the case of including a single question and the case of including a plurality of questions are possible.

In the present invention, the communication terminal device transmits, to the server device, information indicating that there is no answer to the question (answering state information) in the case where a certain period has elapsed (a period from the output of the question screen information has exceeded a time threshold) without acquiring any answer to the question. Thus, even if the user does not answer the question, the server device can confirm the situation where there is no answer. As a result, if the user is so ill that the user cannot answer the question, the server device can grasp a possibility that the user is ill at an early phase.

In the present invention, the communication terminal device outputs, to the external display device, a display switching instruction so as to switch a screen displayed on the external display device to a screen containing a question. Thus, even if the external display device is configured to maintain the display state at the time of the last power-off, the question screen can be displayed on the external display device for sure. Note that such a configuration may correspond to, for example, in the case where the external display device is a television device, a last channel function (function for selecting the channel that has been selected at the time of power-off, when the display device is powered on next time) or a last input function (function for selecting the input line that has been selected at the time of power-off, when the display device is powered on next time in the case where there are a plurality of input lines to be displayed).

In the present invention, in the case where the external display device is a television device, the communication terminal device outputs, to the external display device, a display switching instruction so as to switch a displayed screen to a screen of a received television broadcast upon receipt of information indicating that there has been an end operation after outputting screen information that permits an end operation in response to acquisition of an answer to the question. Thus, once the process of checking the condition of the user ends, the external display device can smoothly enter the state in which the user can watch a television program. This configuration thus increases the compatibility of checking the condition of the user and watching television. The screen information that permits an end operation is output in the case of acquisition of an answer to the question. At that time, both the case of outputting the screen information directly in response to acquisition of an answer to the question and the case of outputting the screen information indirectly in response to acquisition of an answer to the question are covered. The case of outputting the screen information indirectly in response to acquisition indicates that another processing is performed or exists between acquisition of an answer and output of the screen information (the term “case” used in the present invention has both the meanings of directly and indirectly, as for contents other than the above-described one).

In the present invention, if the communication terminal device is capable of providing proper screen information containing content uniquely provided by the communication terminal device, the communication terminal device outputs, to the external display device, the proper screen information upon acquisition of information indicating that there has been an end operation after outputting the screen information that permits an end operation in response to acquisition of an answer to the question. Thus, the proper screen information of the communication terminal device can be presented to the user via the display device. The proper screen information may correspond to information based on a home screen (home menu screen) of the communication terminal device, a screen of content output by the communication terminal device at the time of the last power-off, a screen of application software provided by the communication terminal device, a VOD request screen if the communication terminal device supports VOD (Video On Demand).

In the present invention, in the case where the external display device is a television device, the communication terminal device outputs, to the external display device, a display switching instruction so as to switch a displayed screen to a screen of a received television broadcast, when a certain period has elapsed (when a period from the output of the question screen information has exceeded a time threshold) even if the user does not answer the question. Thus, the state where the user is prevented from watching a television program is avoided, and a certain degree of convenience for the user can be ensured. Note that the state where the user does not answer the question may be a state where the user does not feel like answering the question as well as a state where the user is so ill that the user cannot answer the question. It is preferable to allow the user who does not feel like answering the question to watch a television broadcast.

In the present invention, the communication terminal device outputs a display switching instruction so that the question screen is displayed again, after a certain period has elapsed since a television broadcast has become viewable. Thus, the user is provided again with an opportunity to answer the question and can be prompted to answer the question.

In the present invention, the communication terminal device transmits, to the server device, a notification indicating that an unusual situation has occurred to the user if there is no answer from the user even after display of a television broadcast and re-display of the question screen have been sequentially repeated a certain number of times (the number of times of repetition has exceeded a number-of-times threshold). Thus, the server device can grasp that it is highly likely that an unusual situation has occurred to the user, and can take a watch-over action more readily.

In the present invention, the communication terminal device outputs antecedent information so as to allow a user operation prior to the question screen information. Thus, a situation in which the user can perform an operation can be provided prior to the question. In addition, if information indicating that there has been a user operation for the antecedent information, such information allows the server device to confirm that the user is alive prior to the question. Content of the antecedent information may be an instruction or a request to the user, such as “Please press a button” or a question, such as “What are your stars today?”. Other than those, content that causes the user to feel like performing an operation can be employed. From a point of view in which checking whether the user is alive is prioritized, it is important to employ content that causes the user to perform an operation.

In the present invention, the communication terminal device transmits, to the server device, a notification indicating that there has been a user operation in the case of acquisition of information indicating that there has been a user operation for the antecedent information. Thus, the server device can immediately confirm that the user is able to perform an operation, that is, the user is alive.

In the present invention, the communication terminal device transmits, to the server device, a notification indicating that there is no user operation if there is no user operation even after a reference period has elapsed from the output of the antecedent information. Thus, the server device can grasp that something may be wrong with the user at an early phase before outputting the question screen information and get ready for the case where it is necessary to actually visit the user as soon as possible.

In the present invention, the question is transmitted from the server device to the communication terminal device. Thus, the server device can change the content of the question, and a timely question can be provided to the user in accordance with the season, the time slot, or the day of the week.

### Advantageous Effects of Invention

In the present invention, a communication terminal device is connected to a display device such as a television device so as to allow the display device to communicate with a server device. In addition, the display device is caused to display a question through a process performed by the communication terminal device in response to a power-on operation on the display device. Thus, the display function of the display device is effectively used in a watch-over service, and the server device can check, based on a question answering state of the user, the condition of a monitoring-target person much more easily and in more detail than in the related art, without requiring various monitoring sensors.

In the present invention, even in the case where the user does not answer the question, the server device can confirm the situation where there is no answer, and the communication terminal device can perform a subsequent process in response to the situation. Thus, a process of the watch-over system can be appropriately carried out regardless of the answering state of the user.

In the present invention, the communication terminal device outputs, to the external display device, a display switching instruction so as to switch a screen displayed on the external display device to a screen containing a question. Thus, the question screen can be displayed on the external display device for sure, and the user can be provided with an opportunity to answer the question.

In the present invention, in the case where the external display device is a television device, the communication terminal device outputs, to the external display device, a display switching instruction so as to switch the displayed screen to a screen of a television program when a process of checking the condition of the user ends. Thus, the external display device can enter a state in which the user can watch a television program.

In the present invention, if the communication terminal device is capable of providing proper screen information containing content uniquely provided by the communication terminal device, the proper screen information can be presented to the user by the external display device when a process of checking the condition of the user ends. Thus, the user can enjoy various kinds of content other than a television broadcast.

In the present invention, in the case where the external display device is a television device, a screen of a received television broadcast is displayed after a certain period has elapsed even if the user does not answer the question. Thus, a state where the user is prevented from watching a television program is avoided, and a certain degree of convenience for the user can be ensured.

In the present invention, the communication terminal device outputs a display switching instruction so that the question screen is re-displayed after a certain period has elapsed since a television broadcast has become viewable. Thus, the user is provided again with an opportunity to answer the question.

In the present invention, the communication terminal device transmits, to the server device, a notification indicating that an unusual situation has occurred to the user if there is no answer from the user even after display of a television broadcast and re-display of the question have been repeated a certain number of times. Thus, the server device can grasp that it is highly likely that an unusual situation has occurred to the user.

In the present invention, the communication terminal device outputs antecedent information prior to the question screen information so that a user operation can be performed. Thus, an opportunity to immediately check whether the user is alive can be ensured.

In the present invention, the communication terminal device transmits, to the server device, a notification indicating that there has been a user operation in the case of acquisition of information indicating that there has been a user operation for the antecedent information. Thus, the server device can immediately confirm that the user is alive.

In the present invention, the communication terminal device transmits, to the server device, a notification indicating that there is no user operation if there is no user operation even after a reference period has elapsed from the output of the antecedent information. Thus, the server device can grasp that something may be wrong with the user at an early phase.

In addition, in the present invention, the server device transmits, to the communication terminal device, the question contained in the question screen information output to the external display device. Thus, the server device can appropriately change the content of the question, and can increase the interest and curiosity of the user concerning the question.

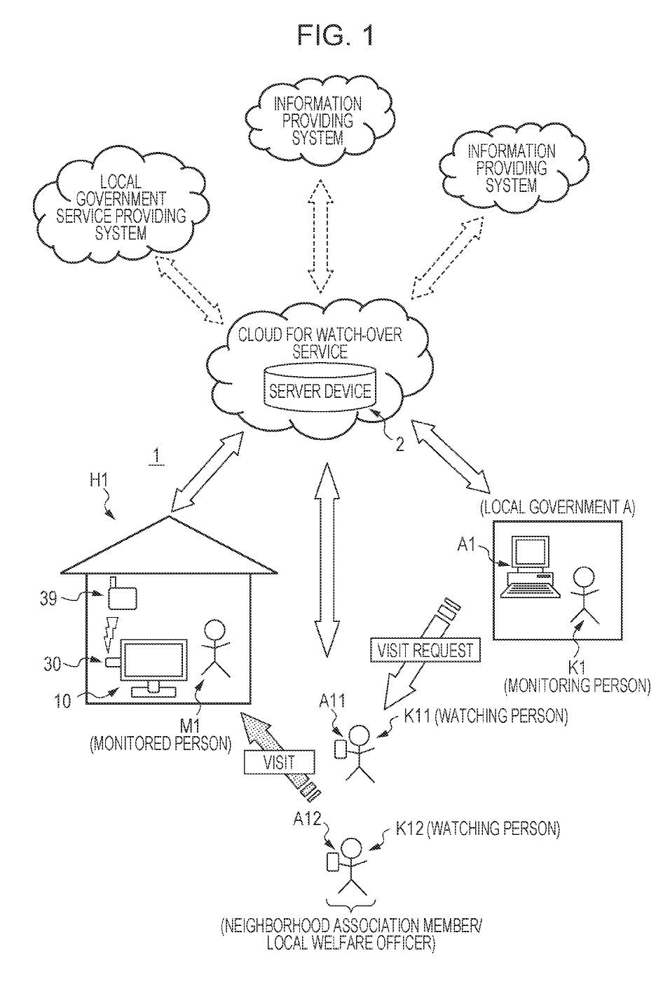

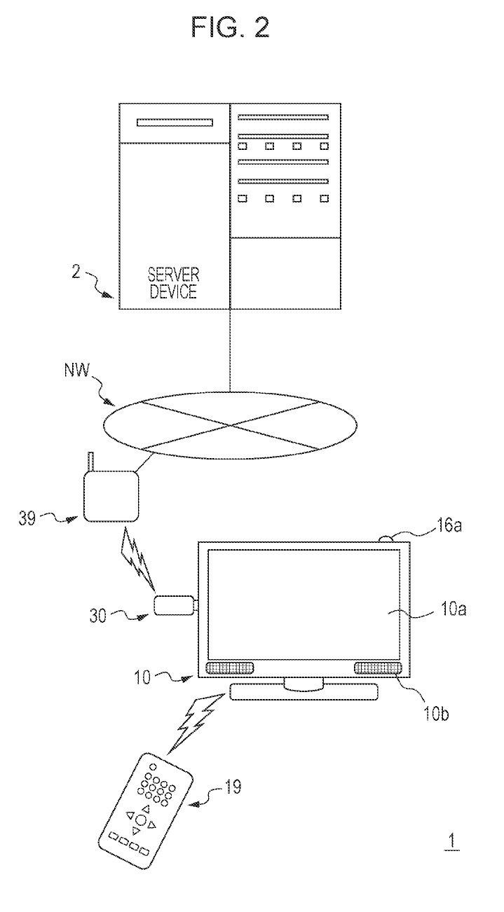

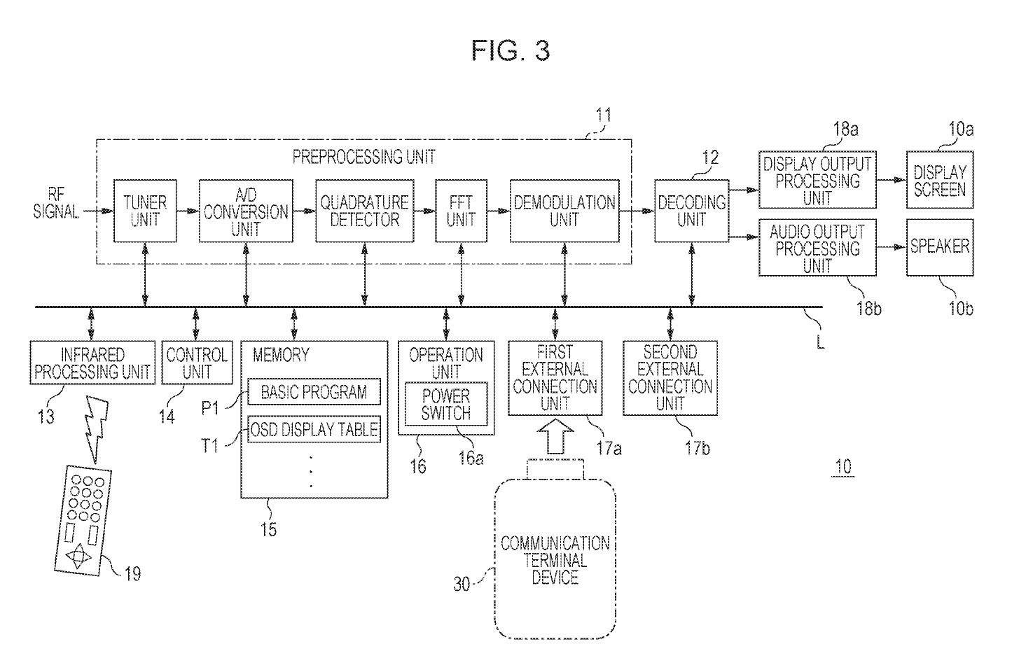

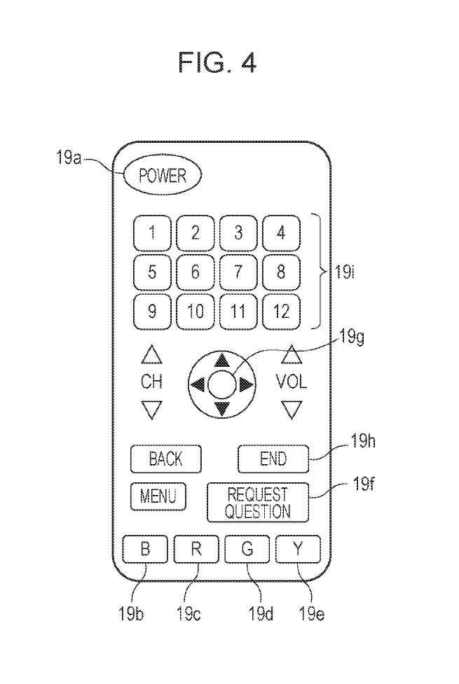

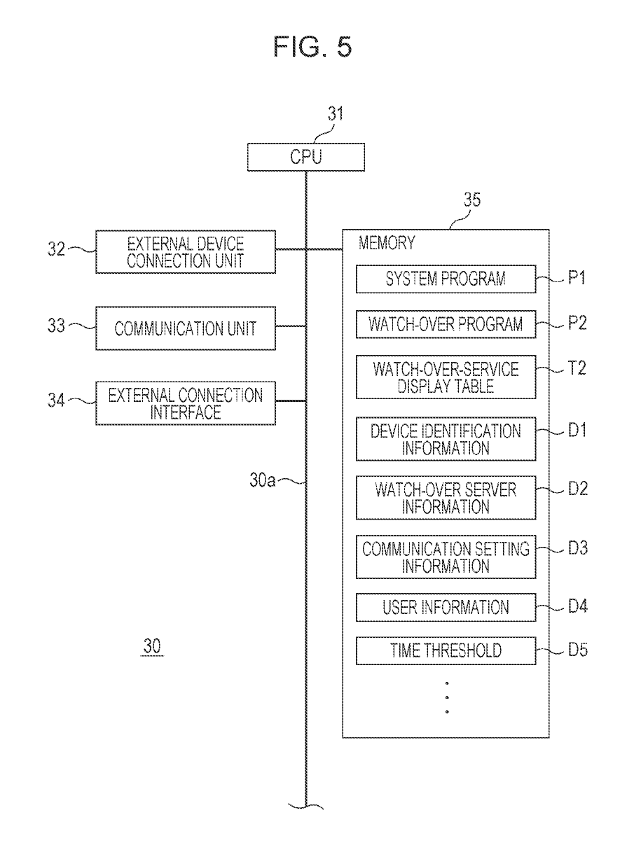

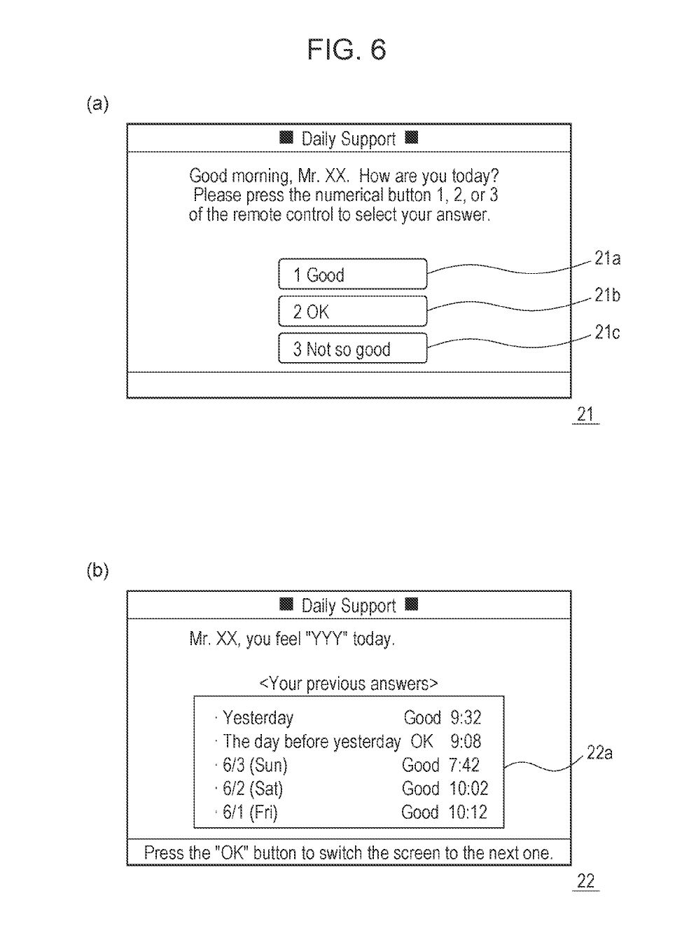

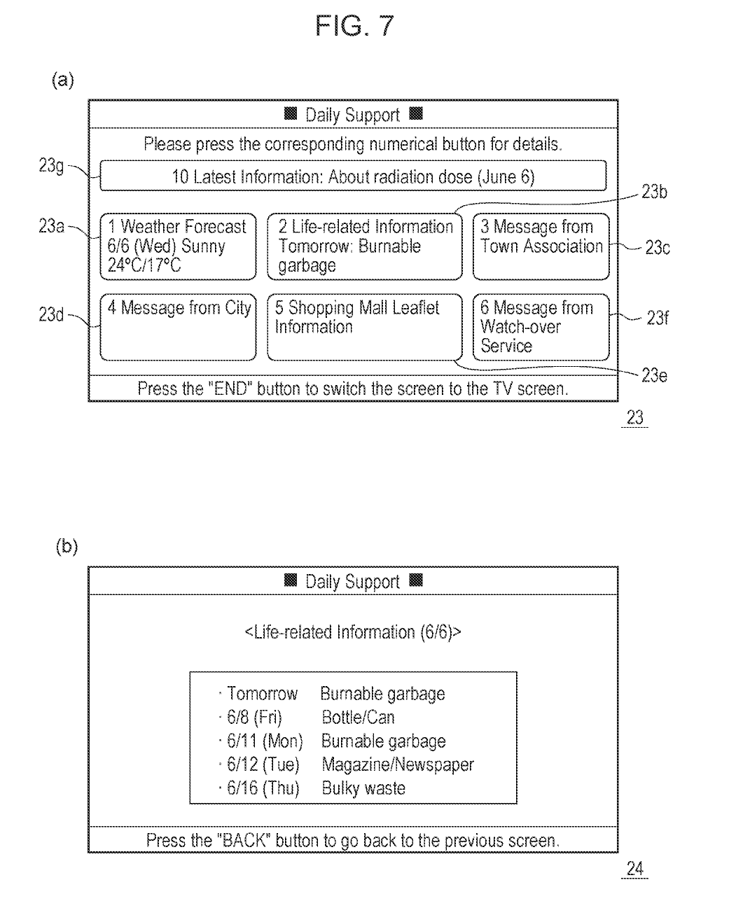

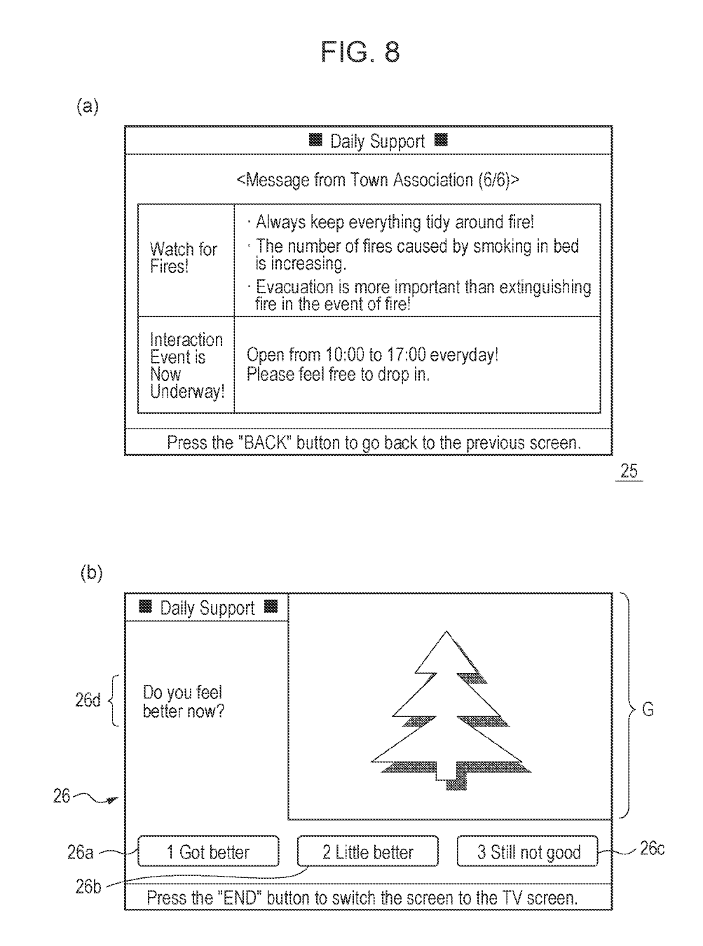

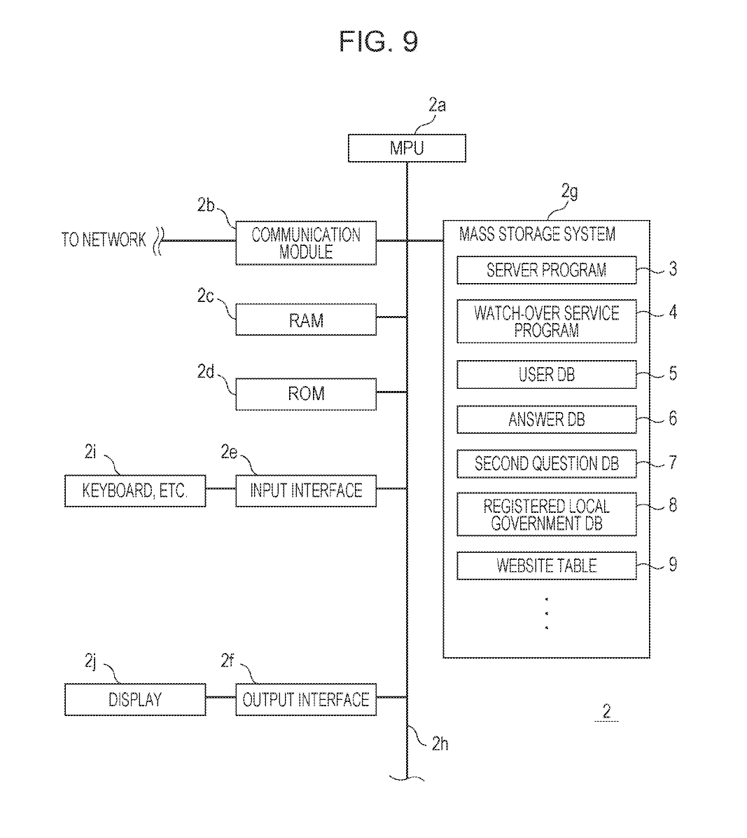

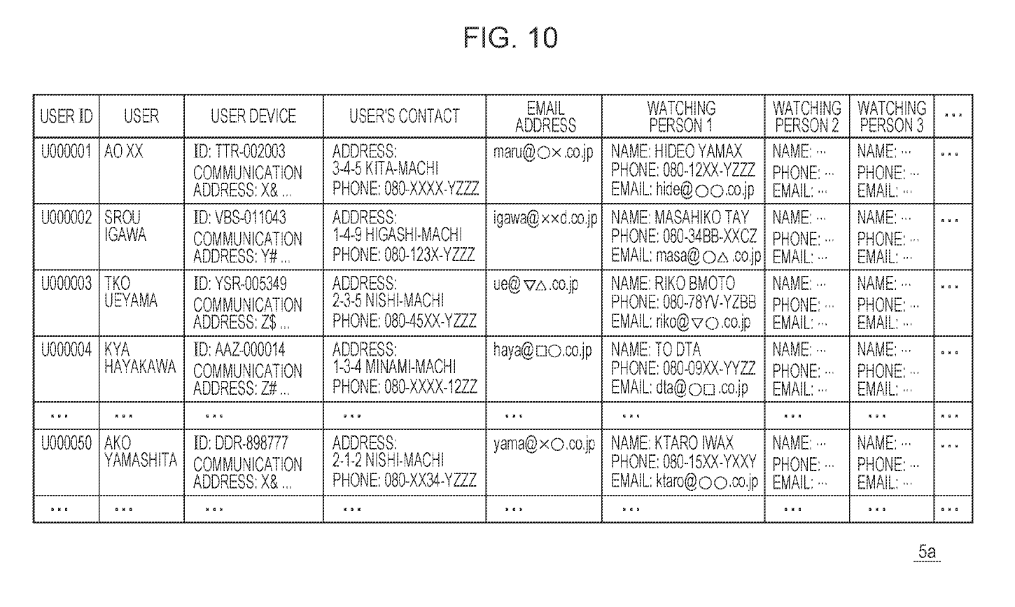

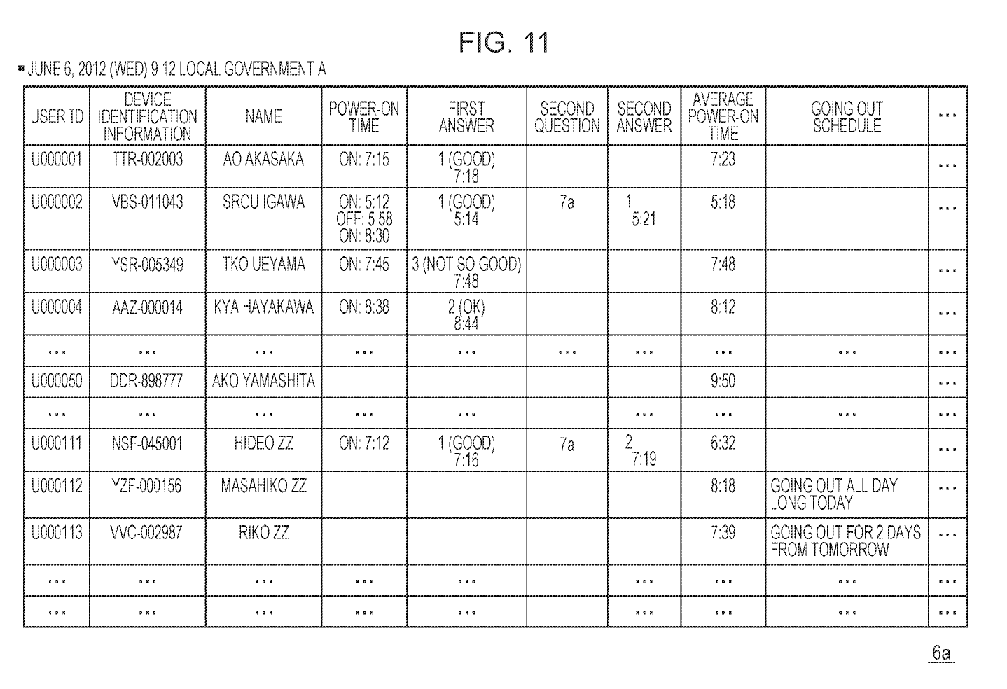

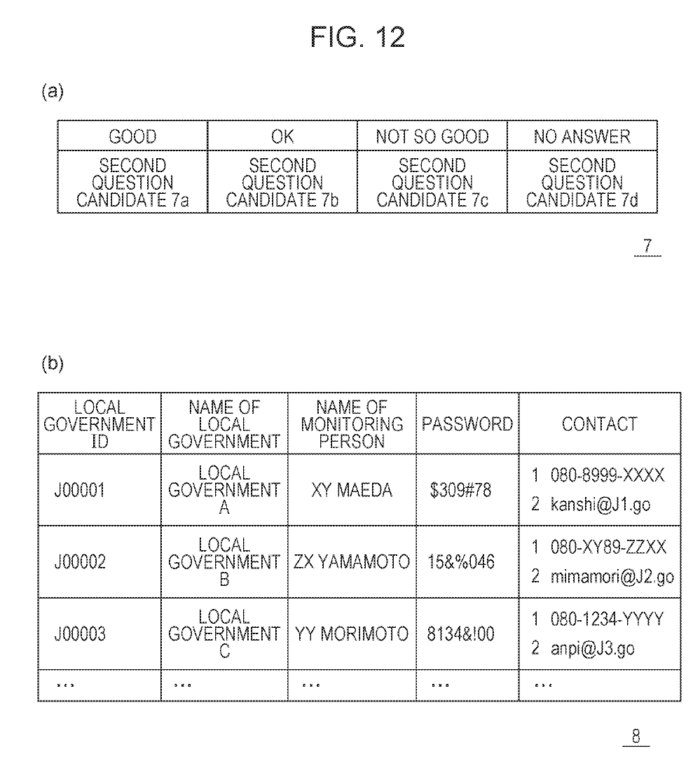

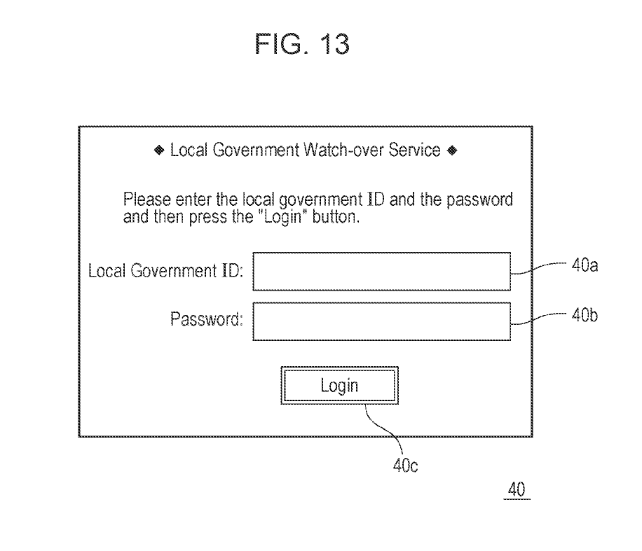

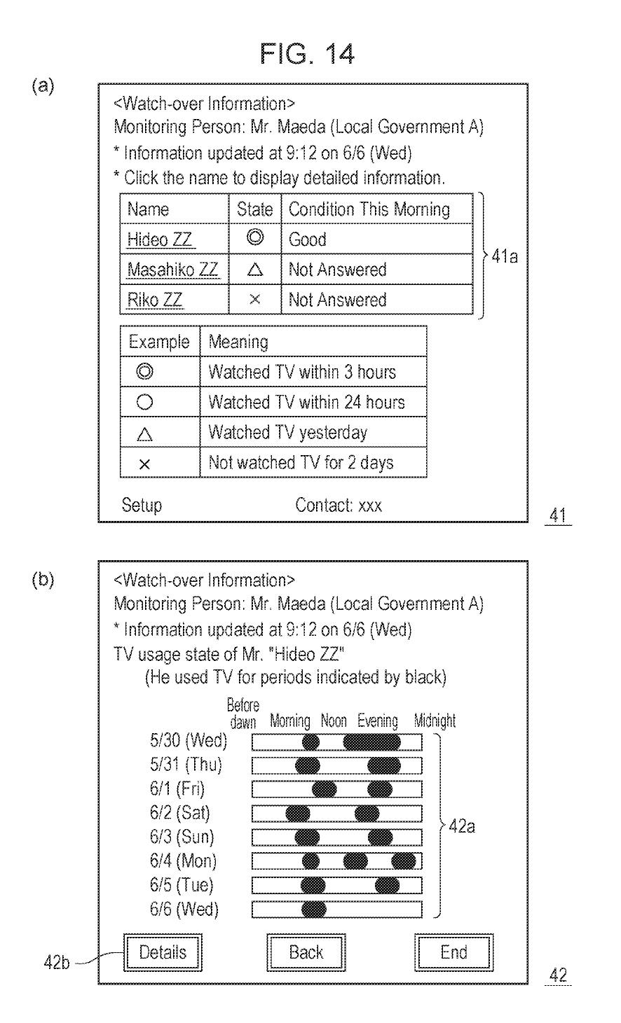

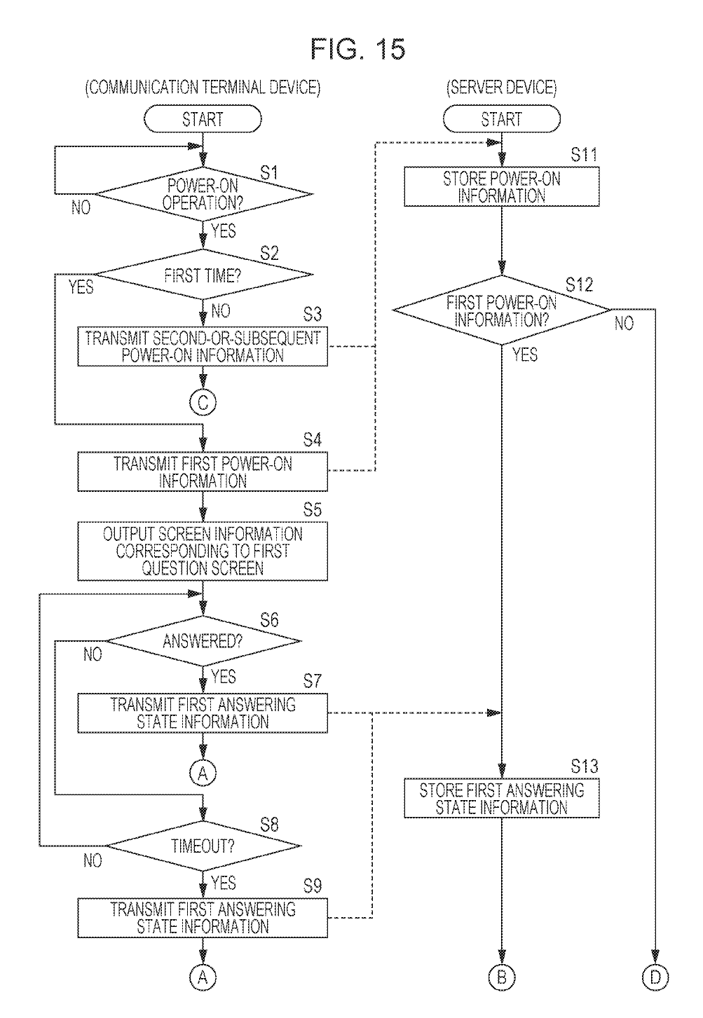

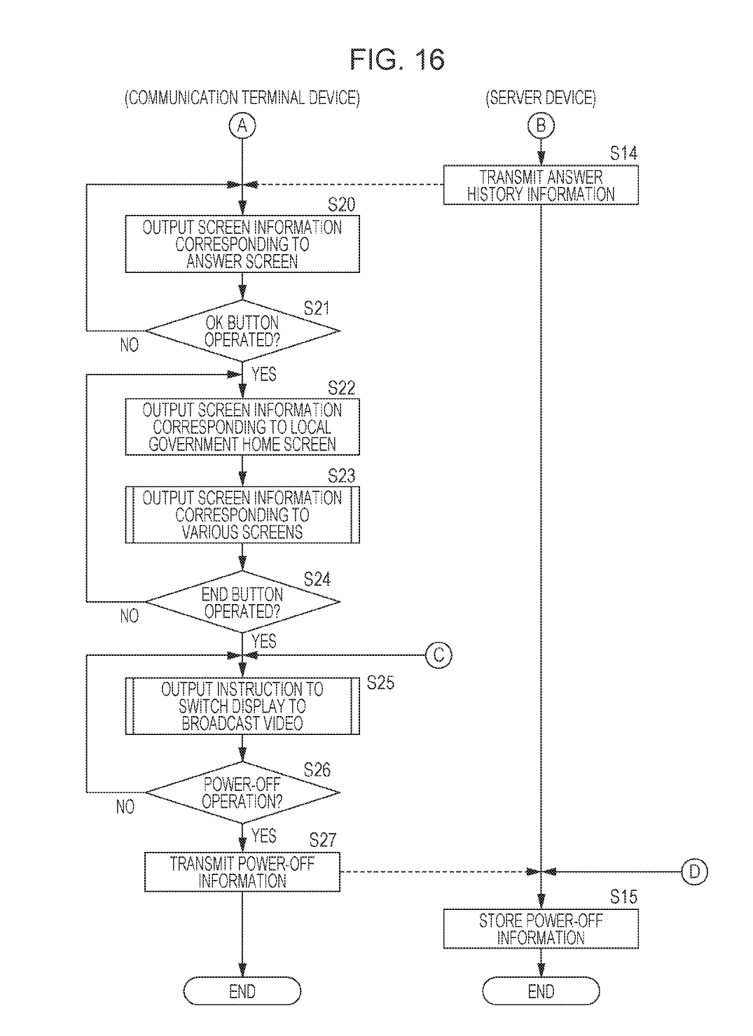

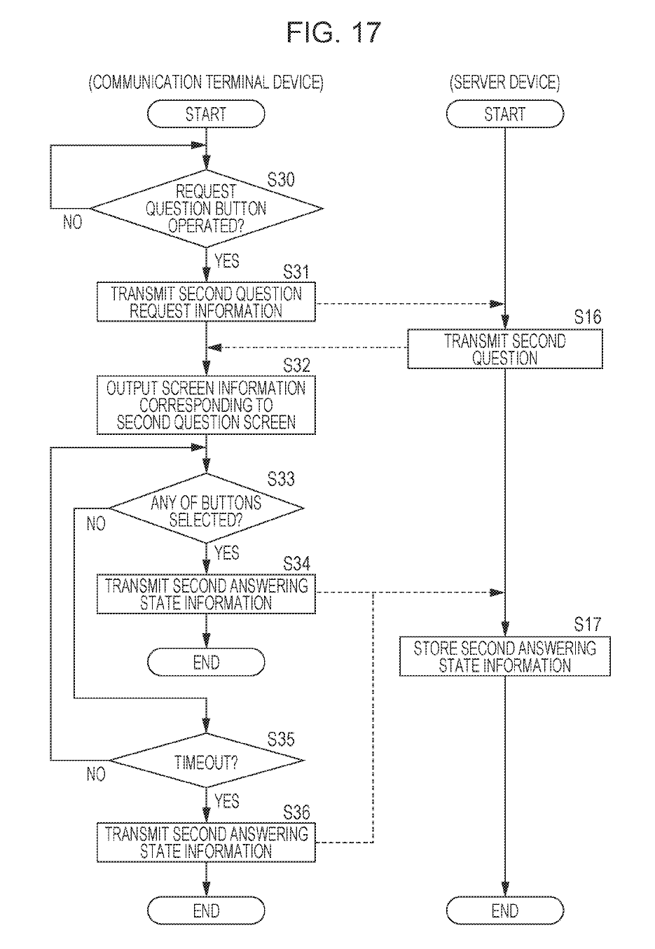

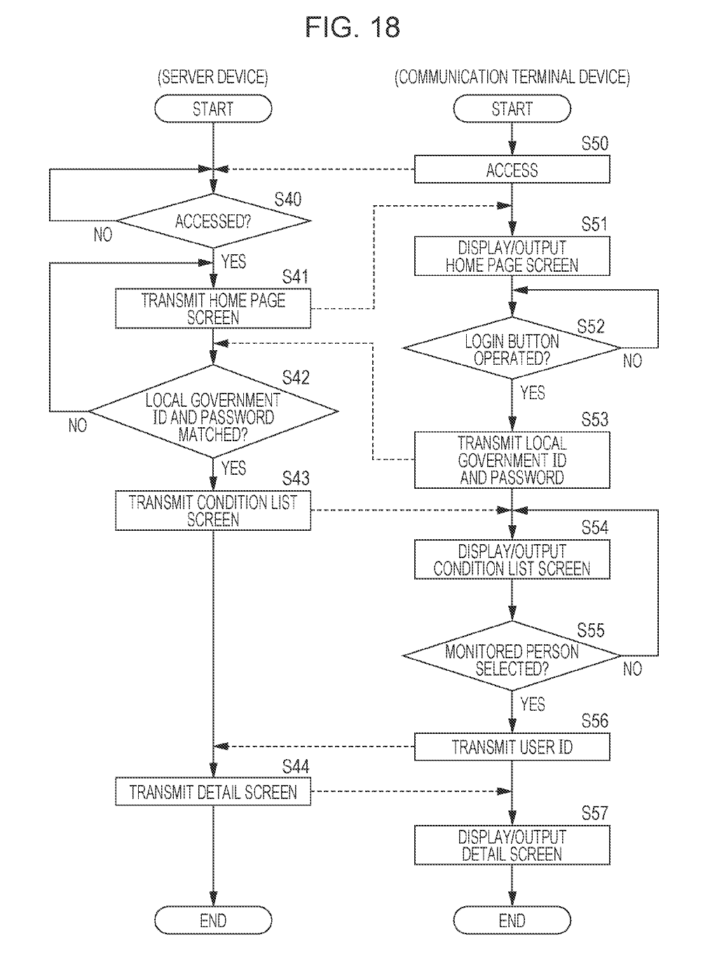

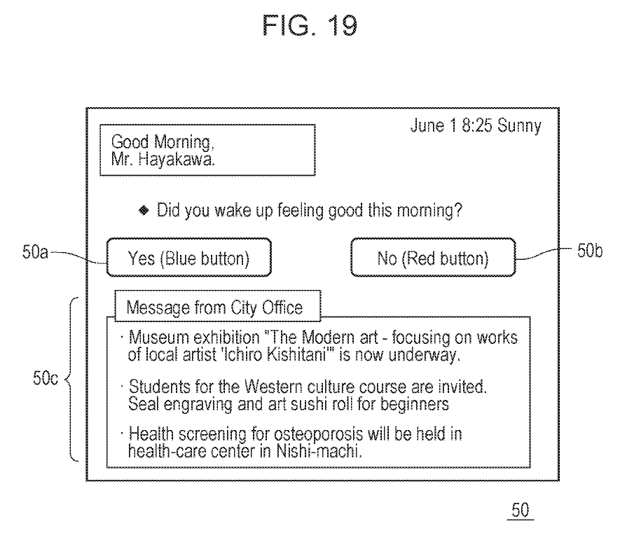

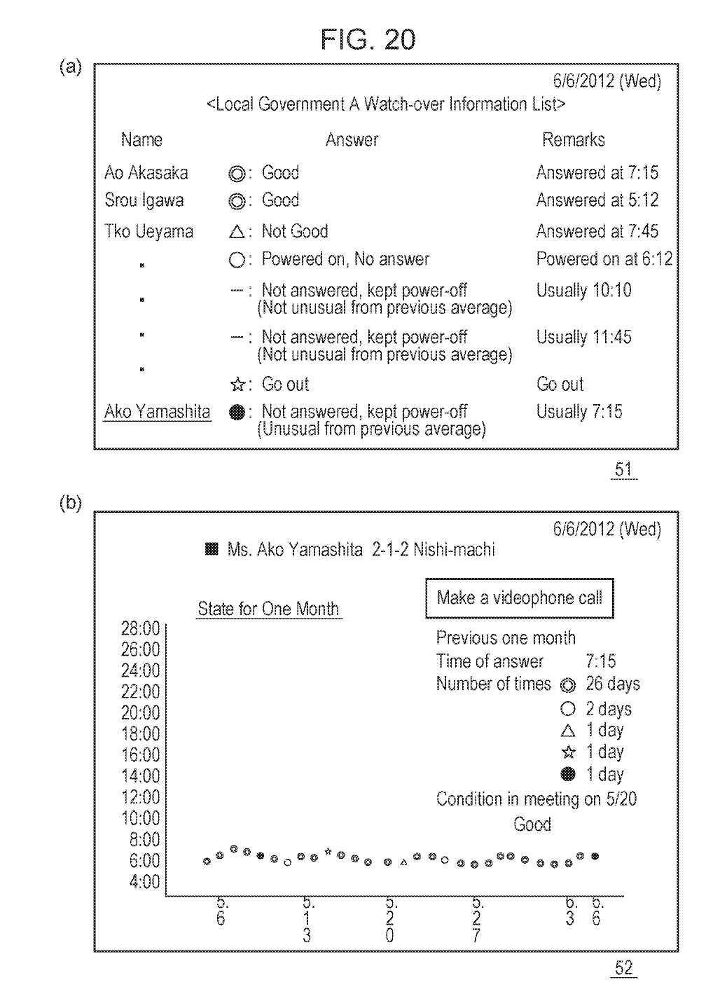

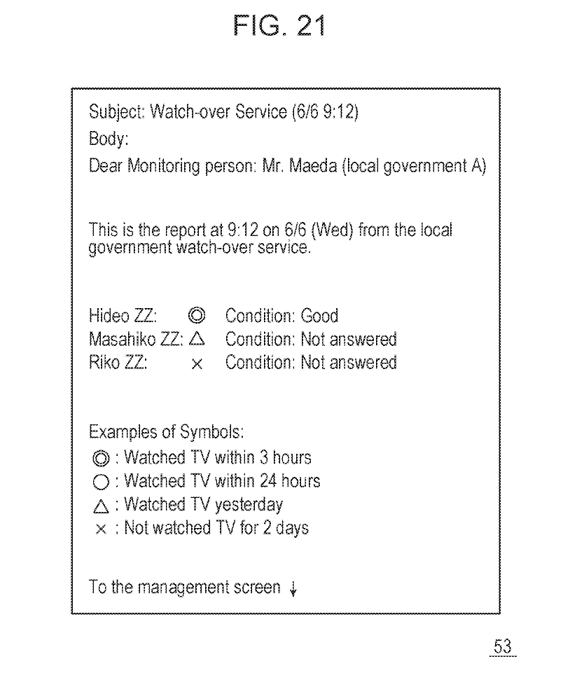

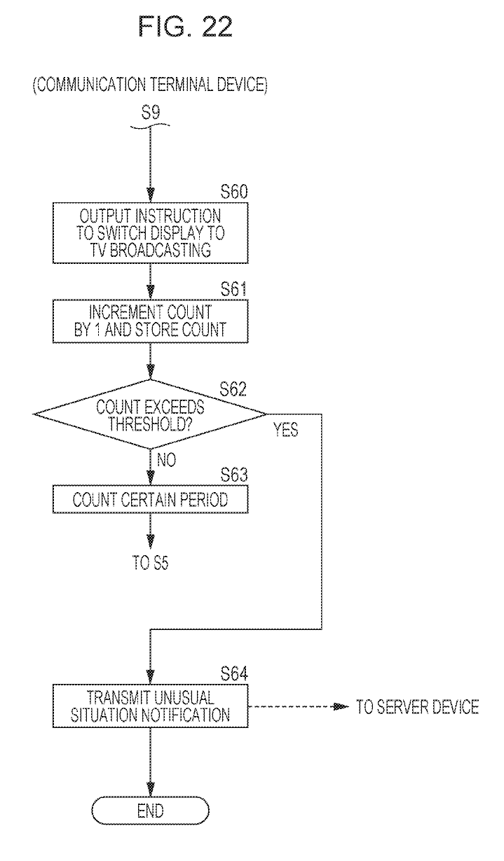

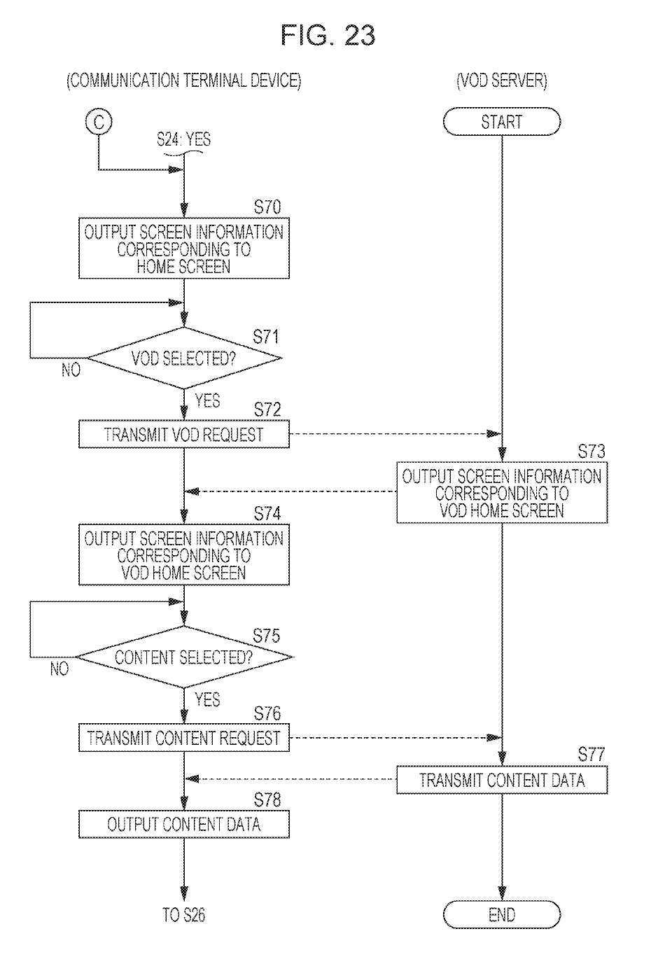

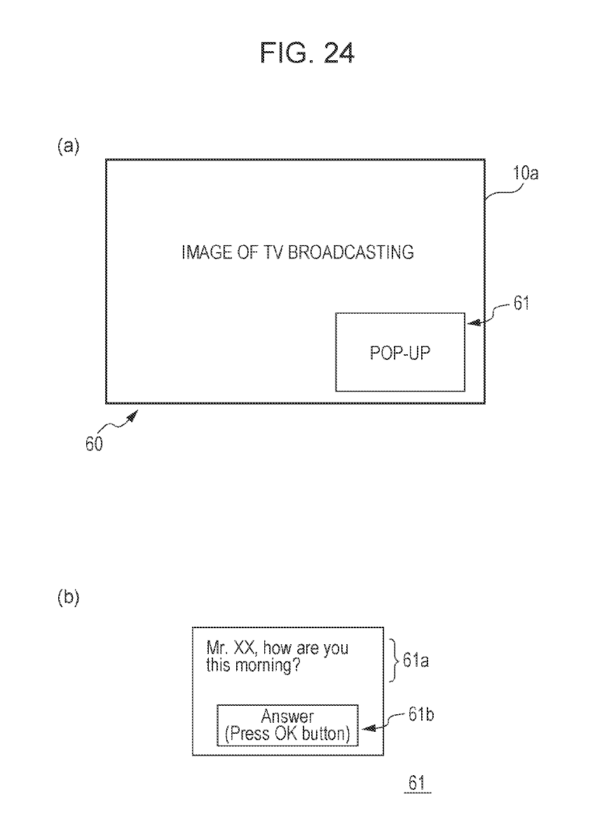

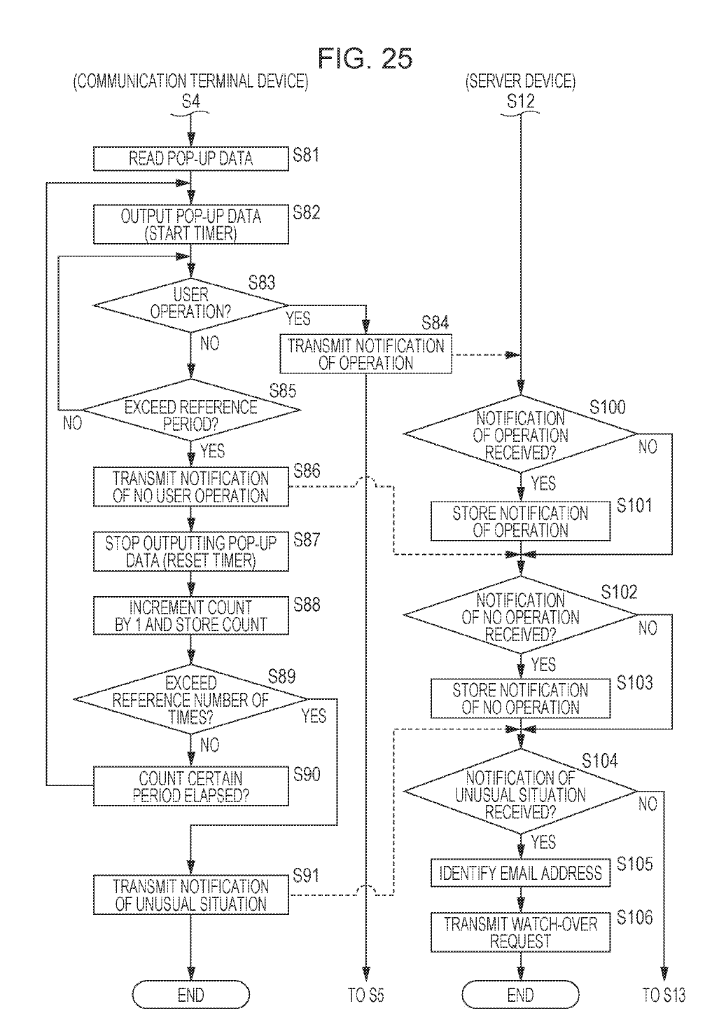

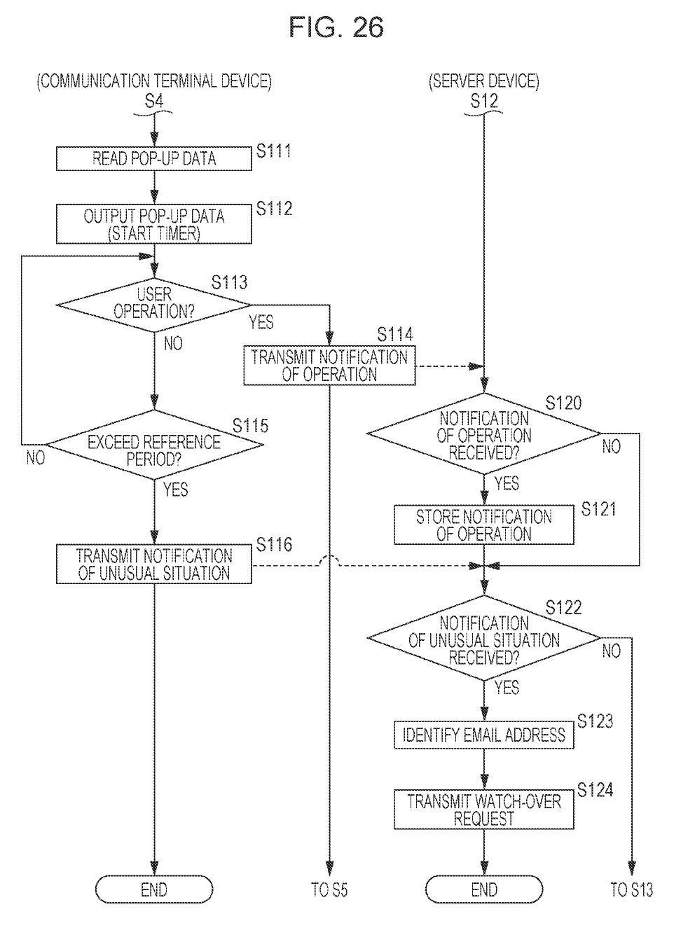

### BRIEF DESCRIPTION OF DRAWINGS

[FIG. 1] is a schematic diagram illustrating the overview of a watch-over service provided by a local government by using a user condition checking system according to an embodiment of the present invention.

[FIG. 2] is a schematic diagram illustrating major components of the user condition checking system according to the embodiment.

[FIG. 3] is a block diagram illustrating major internal components of a television device.

[FIG. 4] is a schematic diagram illustrating the overview of a remote control.

[FIG. 5] is a block diagram illustrating major internal components of a communication terminal device.

[FIG. 6] Part (a) is a schematic diagram illustrating a first question screen, and part (b) is a schematic diagram illustrating an answer screen.

[FIG. 7] Part (a) is a schematic diagram illustrating a local government home screen, and part (b) is a schematic diagram illustrating a life-related information screen.

[FIG. 8] Part (a) is a schematic diagram illustrating a neighborhood association information screen, and part (b) is a schematic diagram illustrating a second question screen.

[FIG. 9] is a block diagram illustrating major internal components of a server device.

[FIG. 10] is a table illustrating an example of a user DB (database) of a certain local government.

[FIG. 11] is a table illustrating an example of an answer DB of a certain day of a certain local government.

[FIG. 12] Part (a) is a table illustrating a second question DB, and part (b) is a table illustrating a registered local government DB.

[FIG. 13] is a schematic diagram illustrating the overview of a homepage screen.

[FIG. 14] Part (a) is a schematic diagram illustrating a condition list screen, and part (b) is a schematic diagram illustrating a detail screen.

[FIG. 15] is a first flowchart illustrating a procedure of a user condition checking method (or a user condition notification method).

[FIG. 16] is a second flowchart illustrating a procedure of the user condition checking method (or the user condition notification method).

[FIG. 17] is a third flowchart illustrating a procedure of the user condition checking method (or the user condition notification method).

[FIG. 18] is a fourth flowchart illustrating a procedure of the user condition checking method.

[FIG. 19] is a schematic diagram illustrating the first question screen according to a modification.

[FIG. 20] Part (a) is a schematic diagram illustrating the condition list screen according to a modification, and part (b) is a schematic diagram illustrating the detail screen according to a modification.

[FIG. 21] is a schematic diagram illustrating contents of an email.

[FIG. 22] is a fifth flowchart illustrating a procedure of the user condition checking method (or the user condition notification method) according to a second embodiment of the present invention.

[FIG. 23] is a sixth flowchart illustrating a procedure of the user condition checking method according to a third embodiment of the present invention.

[FIG. 24] illustrates a pop-up screen according to a fourth embodiment of the present invention, part (a) is a schematic diagram illustrating a state where the pop-up screen is displayed in a displayed screen, and part (b) is a schematic diagram illustrating details of the pop-up screen.

[FIG. 25] is a seventh flowchart illustrating a procedure of the user condition checking method (or the user condition notification method) according to a fourth embodiment of the present invention.

[FIG. 26] is an eighth flowchart illustrating a procedure of the user condition checking method (or the user condition notification method) according to a modification of the fourth embodiment.

### DESCRIPTION OF EMBODIMENTS

### First Embodiment

FIG. 1 illustrates the overview of a user condition checking system 1 according to a first embodiment of the present invention that is used for a watch-over service provided by a local government. The watch-over service illustrated in FIG. 1 is configured in the following manner. A monitoring person K1 of a local government A remotely monitors, by using the user condition checking system 1, the condition of a person (a monitored person M1 who is a monitoring target) who lives in a house H1 in an area which belongs to the local government. If the monitoring person K1 of the local government A determines that it is necessary to visit the monitored person H1 as a result of the monitoring, the monitoring person K1 transmits a notification (e.g., a visit request) to watching persons K11 and K12 who are neighborhood association members or local welfare officers. Upon receipt of such a notification, the watching persons K11 and K12 visit the monitored person M1 to check the condition of the monitored person M1.

In the user condition checking system 1, a television device 10 (corresponding to an external display device) that is operated by a user (i.e., the monitored person M1) is directly connected to a communication terminal device 30. This communication terminal device 30 acquires various pieces of information based on user operations performed on the television device 10 from the television device 10 and transmits the acquired information to a server device 2 via a router 39 installed in the house H1 and a network so as to allow the server device 2 to remotely check the condition of the monitored person M1. The present invention is characterized in that the display function of the television device 10 is effectively used. Specifically, a question to the monitored person M1 or the like is displayed on the television device 10, and the communication terminal device 30 transmits a question answering state to the server device 2 so as to allow the server device 2 to check the details about the monitored person.

In addition, the server device 2 provides a cloud service for a watch-over service. The server device 2 is also linked to a local government service providing system and a plurality of other information providing systems (such as a weather forecast providing system, a city information providing service, and a shopping mall information providing service) via a communication network. The server device 2 is capable of acquiring various kinds of information provided by individual servers that constitute these various systems and providing the various kinds of information to the monitored person M1. Further, the server device 2 provides a website for monitoring persons of local governments on the Internet. Through this website, the server device 2 allows the monitoring person K1 of each local government registered in the watch-over service to remotely check the condition of the monitored person M1 by using a communication terminal A1 and allows the monitoring person K1 to notify mobile communication terminals A11 and A12 respectively used by the watching persons K11 and K12 of an instruction.

As the communication terminal A1 used by the monitoring person K1, a personal computer with a communication function or a mobile communication terminal (such as a notebook personal computer with a communication function, a smartphone, a PDA with a communication function, or a mobile phone) can be employed. In addition, as the mobile communication terminals A11 and the like used by the watching persons K11 and K12, a notebook personal computer with a communication function, a smartphone, a PDA with a communication function, or a mobile phone can be employed. As a means for communication of the communication terminal A1, wireless communication based on various standards as well as wired communication can be employed. As a means for communication of the mobile communication terminals A11 and the like used by the watching persons K11 and K12, wireless communication based on various standards is preferably used.

In order to simplify the drawing, FIG. 1 illustrates only one monitored person M1; however, the watch-over service according to the present invention obviously can handle the case where the service is utilized by a plurality of monitored persons. Similarly, FIG. 1 illustrates only one monitoring person K1 of the local government A; however, the watch-over service according to the present invention can handle a plurality of monitoring persons. Further, FIG. 1 illustrates only one local government A; however, the watch-over service according to the present invention can handle a plurality of local governments (such as a local government B, a local government C, and so on other than the local government A) and is able to construct a system including, for each local government, monitored persons, monitoring persons, and watching persons. The user condition checking system 1 that constitutes a major part of the watch-over service illustrated in FIG. 1 will be described in detail below.

FIG. 2 illustrates major components of the user condition checking system 1 according to the embodiment of the present invention. In the user condition checking system 1, the server device 2 and the communication terminal device 30 are connected to each other via the wireless router 39 and a communication media such as a network NW so as to be able to communicate with each other. The communication terminal device 30 is also connected to the television device 10 on which various operations are performed by the user. The communication terminal device 30 presents various kinds of screen information output thereby to the user (i.e., the monitored person M1) by using the display function of the television device 10. The television device 10 illustrated in FIG. 2 includes a display screen 10a and speakers 10b on a front surface of its casing and includes a power switch 16a on the casing. The television device 10 accepts various operations performed with a remote control 19 by the user (e.g., the monitored person M1).

FIG. 3 illustrates the overview of major internal components of the television device 10. The television device 10 includes a preprocessing unit 11, a decoding unit 12, an infrared processing unit 13, a control unit 14, a memory 15, an operation unit 16, a first external connection unit 17a, a second external connection unit 17b, a display output processing unit 18a, and an audio output processing unit 18a which are connected to each other via an internal connection line L. In addition, each of these units such as the unit 11 transmits and receives a signal to and from the control unit 14 via the internal connection line L. Specifically, each unit such as the unit 11 transfers a signal indicating the current processing status or the like to the control unit 14. The control unit 14 grasps the current processing status from the processing status or the like transferred from the each unit such as the unit 11. The control unit 14 sends a control signal for controlling a process to be performed next to each unit such as the unit 11 in accordance with the grasped status. Each unit of the television device 10 will be described below.

The preprocessing unit 11 includes a tuner unit, an A/D conversion unit, a quadrature detector, an FFT unit, and a demodulation unit. The preprocessing unit 11 is fed with an RF signal (digital broadcast signal) obtained with an antenna, performs a certain process on this input signal to obtain a demodulated transport stream (TS), and transfers the transport stream to the decoding unit 12 that performs a subsequent process. The decoding unit 12 performs a decoding process on the demodulated transport stream obtained by the preprocessing unit 11 to demultiplex the transport stream into a video stream, an audio stream, and other data. The decoding unit 12 performs a video decoding process on the obtained video stream and outputs the resulting stream to the display output processing unit 18a. The decoding unit 12 also performs an audio decoding process on the obtained audio stream and outputs the resulting stream to the audio output processing unit 18b.

The display output processing unit 18a performs a process necessary for displaying a certain video image to generate a video signal and outputs the generated video signal to the display screen 10a. In this way, a broadcast video image of a broadcast program or the like is output to the display screen 10a for display, and a screen of the received television broadcast is displayed on the display screen 10a. In addition, the audio output processing unit 18b performs a certain process necessary for audio output, such as amplification, to generate an audio signal and outputs the generated audio signal to the speakers 10b so as to output various kinds of sound from the speakers 10c.

The operation unit 16 and the infrared processing unit 13 are provided as parts related to an interface with the user. The operation unit 16 is a user interface provided on the casing of the television device 10 and includes buttons such as a volume changing button, a channel switching button, an input switching button as well as the power switch 16a for power on/off. The infrared processing unit 13 performs a communication process (signal/data transmission/reception process) according to a known infrared standard (e.g., each standard of the IrDA series). The infrared processing unit 13 basically performs a process of receiving infrared light containing an operation signal emitted from the remote control 19 which accepts an operation from the user and of transferring the operation signal to the control unit 14.

FIG. 4 illustrates the remote control 19 that emits infrared light toward the infrared processing unit 13 described above. The remote control 19 includes a power switch 19a for powering on/off the television device 10 at a top end portion thereof; numerical buttons 19i including twelve buttons in total; left, right, top, and bottom keys; an OK button 19g; a volume adjustment key; a channel switching key; a question request key 19f; a back button; an end button 19h; a menu button; and four color buttons (i.e., a blue button 19b, a red button 19c, a green button 19d, and a yellow button 19e). Upon accepting an operation from the user with each of these buttons and switches, the remote control 19 emits infrared light indicating content of the accepted operation. Note that a power-on operation or a power-off operation is performed on the television device 10 in response to the user operating the power switch 16a of the above-described operation unit 16 or the power switch 19a of the remote control.

Referring back to FIG. 3, the description of the internal components of the television device 10 will be continued. The television device 10 includes the plurality of external connection units 17a and 17b. One of them, i.e., the first external connection unit 17a, is compliant with the HDMI (registered trademark) (High-Definition Multimedia Interface) standard, which is a communication interface standard for transmitting video, audio, control signals as digital signals. The communication terminal device 30 can be connected to the first external connection unit 17a. The second external connection unit 17b has a configuration similar to the first external connection unit 17a.

The control unit 14 plays a central role when various functions of the television device 10 are executed. The control unit 14 performs various processes (such as a communication control process, an OSD display process, and an information output process) on the basis of various processing contents defined by a basic program P1 stored in the memory 15. The memory 15 also stores an OSD display table T1 and the like, in addition to the aforementioned basic program P1.

The basic program P1 corresponds to firmware and a system program or the like of the television device 10 and defines various processes performed by the control unit 14 to causing the television device 10 to execute various functions of a television device (such as various functions for viewing television and communication functions). In particular, the basic program P1 according to the embodiment defines that, if some kind of operation is performed on the operation unit 16 or the remote control 19 by the user, information indicating that there has been a user operation is output via the first external connection unit 17a or the second external connection unit 17b described above.

For example, the basic program P1 defines that, in response to a power-on operation performed on the operation unit 16 or the remote control 19, the control unit 14 performs control so that information indicating that there has been a power-on operation is output from the first external connection unit 17a or the like. In addition, the basic program P1 defines that, when content (such as a question screen) allowing the user to perform a selection operation is displayed on the display screen 10a, the control unit 14 performs control so that content of the operation performed by the user on any of the left, right, top, and bottom keys, the OK button 19g, and the like of the remote control 19 (e.g., content indicating that “1” is pressed among the numerical buttons of the remote control 19, content indicating that the OK button 19g is pressed, content indicating that the end button 19h is pressed, or content indicating that the back button is pressed) is output from the first external connection unit 17a or the like.

The television device 10 further includes a plurality of input lines for input sources to be displayed on the display screen 10a. Specifically, the television device 10 includes a television broadcasting input line from the preprocessing unit 11 including the tuner unit or the like, an input line from the first external connection unit 17a, and an input line from the second external connection unit 17b, for example. These input lines can be appropriately switched between by an operation of the remote control 19 or the operation unit 16. In addition, if an instruction for switching between these input lines (display switching instruction) is acquired with the external connection unit 17a or 17b, the control unit 14 of the television device 10 performs control to switch the input line in accordance with the acquired display switching instruction and display the content on the display screen 10a in accordance with the instruction. Such control related to display switching is also defined by the basic program P1. The OSD display table T1 stored in the memory 15 is a table that stores data of a plurality of display parts for appropriately performing OSD display of images or text used for various menus or warning, for example.

FIG. 5 illustrates major internal components of the communication terminal device 30. As the communication terminal device 30 used in the embedment, a device generally called a smart stick (smart box), a stick computer, or a smart computer is used. The communication terminal device of such a type does not include a display unit and is used by being connected to an external display device (in the embodiment, the television device 10).

The communication terminal device 30 has a computer-like internal configuration. The communication terminal device 30 is capable of performing desired processes as a result of installation of various application programs. In the embodiment, the communication terminal device 30 is configured to perform various processes of the watch-over service as a result of installation of a watch-over program P2.

The communication terminal device 30 includes a CPU 31, an external device connection unit 32, a communication unit 33, an external connection interface 34, and a memory 35 which are connected to each other via an internal connection line 30a. The CPU 31 performs various processes for controlling the entire device and performs various processes in accordance with the description of various programs installed in the memory 35. The external device connection unit 32 is a connection terminal compliant with the HDMI (registered trademark) standard which enables direction connection to the external connection unit 17a or the like of the television device 10 described above. The communication unit 33 is an interface that performs wireless communication. The communication unit 13 according to the embodiment performs wireless LAN communication based on the standards of the IEEE 802.11 series (such as IEEE 802.11b/g, a). In the embodiment, the wireless LAN router 39 is installed in the house H1 as illustrated in FIGS. 1 and 2. The communication unit 33 can be connected to the network NW via this wireless LAN router 39.

A user interface such as a mouse or a keyboard, or an external storage medium can be connected to the external connection interface 34. In the embodiment, the external connection interface 34 compliant with the USB (Universal Serial Bus) standard is employed.

The memory 35 stores various programs and information. In the embodiment, the memory 35 stores a system program P1, the watch-over program P2, a watch-over-service display table T2, device identification information D1, watch-over server information D2, communication setting information D3, user information D4, and a time threshold D5, for example. The system program P1 is a basic program corresponding to the OS (operating system). The watch-over program P2 is an application program that defines various processes to be performed by the communication terminal device 30 (or the CPU 31) in order to provide the watch-over service of the watch-over service system 1, and details of the watch-over program P2 will be described later.

The watch-over-service display table T2 stored in the memory 35 corresponds to screen information related to the watch-over service and is a table that stores screen information that serves as data of each display part used for displaying information on the display screen 10a of the television device 10. In the embodiment, the watch-over-service display table T2 includes screen information corresponding to various screens illustrated in FIG. 5 to FIG. 7.

FIG. 6(a) illustrates a first question screen 21 based on question screen information. The first question screen 21 includes text representing a question (first question) and includes, as a plurality of answer options for the question, a first button 21a to a third button 21c on which a selection operation can be performed. Note that the first button 21a is selected as a result of an operation of pressing “1” among the numerical buttons of the remote control 19. Similarly, the second button 21b is selected as a result of pressing the numerical button “2”, and the third button 21c is selected as a result of pressing the numerical button “3” (this also applies to a local government home screen 23 illustrated in FIG. 7(a) described later or the like). In addition, at a part “Mr. XXX” of the text, a user name (or a nickname) included in the user information D4 described later is read from the memory 35 and is pasted. In addition, as for the phrase “Good morning” included in the text, a greeting appropriate for the time slot is pasted. Text for other greetings such as “Good afternoon” and “Good evening” is included in the watch-over-service display table T2.

FIG. 6(b) illustrates an answer screen 22 based on answer screen information. The central portion of the screen is a location where answer information 22a transmitted from the server device 2 is pasted. Part data for text “Daily Support” located at the topmost part, text arranged above the answer information 22a, and text (Press the OK button to switch the screen to the next one) located at a bottommost bar-shaped part is included in the watch-over-service display table T2 (the same applies to the first question screen 21 described above). Note that the part “Mr. XXX” of the text located above the answer information 22a is the same as that of FIG. 6(a), and at a part “YYY”, content of the answer selected in FIG. 6(a) is pasted.

FIG. 7(a) illustrates the local government home screen 23 based on screen information which allows an end operation. The homepage of the website provided by the local government service providing system illustrated in FIG. 1 is arranged. Specifically, the homepage of the website is arranged between the text “Daily Support” located at the topmost part and text (Press the End button to switch the screen to the TV screen) located at the bottommost bar-shaped part.

The homepage of the local government service providing system includes a plurality of selection items 23a to 23g. The topmost bar-shaped selection item 23g is associated with a numerical button “10” of the remote control 19 and is linked to a webpage that provides the latest information (e.g., a website that provides radiation dose information). In response to an operation of pressing the numerical button “10”, the corresponding website is accessed and the displayed content is changed to the website. The first selection item 23a located at the top left end is associated with the numerical button “1” of the remote control 19 and is linked to a website that provides a weather forecast.

The second option 23b located at the center of the top row is associated with the numerical button “2” of the remote control 19 and is linked to a webpage that provides life-related information of the neighborhood association. In response to selection of the numerical button “2”, the displayed screen changes to a life-related information (garbage collection day) screen 24 illustrated in FIG. 7(b). The third option 23c located at the top right end is associated with the numerical button “3” of the remote control 19 and is linked to a webpage that provides information related to the neighborhood association. In response to selection of the numerical button “3”, the displayed screen changes to a neighborhood association information screen 25 illustrated in FIG. 8(a).

Further, the fourth selection item 23d located at the bottom left end is associated with the numerical button “4” of the remote control 19 and is linked to a webpage that provides city information. In addition, the fifth option 23e located at the center of the bottom row is associated with the numerical button “5” of the remote control 19 and is linked to a webpage that provides information related to the shopping mall. The sixth option 23f located at the bottom right end is associated with the numerical button “6” of the remote control 19 and is linked to a webpage that provides information related to the company that manages the server device 2.

FIG. 8(b) illustrates a second question screen 26 based on second question screen information. The second question screen 26 surrounds a television broadcasting image G displayed on the display screen 10b in an L-shape. The second question screen 26 includes text 26d indicating a question (second question) and a first button 26a to a third button 26c indicating options for the question. Content of the text 26d and the text of the first button 26a to the third button 26c is based on information transmitted from the server device 2. The transmitted information that is arranged in a manner as illustrated in FIG. 8(b) is the second question screen 26.

In addition, the device identification information D1 stored in the memory 35 is information indicating the identification code of the communication terminal device 30. The device identification information D1 can be used to distinguish this communication terminal device 30 from the other communication devices or the like when communication is performed. The watch-over server information D2 stored in the memory contains information (such as a network address of the server device 2) necessary for the communication terminal device 30 to communicate with the server device 2. The communication setting information D3 contains information (such as the ID of the Internet service provider used by the communication terminal device 30 and an address used to access the server of the Internet service provider) necessary for the communication terminal device 30 to access the Internet via the network NW.

The user information D4 stored in the memory 35 is information concerning the user (the monitored person M1) registered in the watch-over service and contains the name of the user, the nickname of the user, and the identification number (user ID) for identifying the user, for example. The user information D4 including such content is stored in the memory 35 in the following manner. Information (such as the name, the nickname, the address, the age, the gender, the contact address of the watching person, and the password) input by the user in accordance with a certain format at the time of user registration for using the watch-over service is temporarily transmitted to the server device 2. After the user registration has completed, information containing part of the information input by the user is transmitted from the server device 2 to the communication terminal device 30 as the user information D4. The transmitted user information D4 is then stored in the memory 35.

Further, the time threshold D5 stored in the memory 35 is used in one of processes defined by the watch-over program P2, which is described later. In the embodiment, the time threshold D5 is set to 3 minutes by default; however, the time threshold D5 can be set to a desired value in a range from 10 seconds to 10 minutes through a setup menu not illustrated.

Details of the watch-over program P2 will be described next. The watch-over program P2 stored in the memory 35 is an application program that defines processes performed by the communication terminal device 30 in order to carry out the watch-over service according to the present invention (the service according to the user condition checking system 1). The watch-over program P2 is appropriately installed in the memory 35 of the communication terminal device 30 as an application (note that the watch-over program P2 may be obviously pre-installed in the memory 35 when the communication terminal device 30 is manufactured). The watch-over program P2 defines contents of processes performed by the CPU 31 for the watch-over service. Specifically, the watch-over program P2 defines various contents of processes described below.

First, the watch-over program P2 defines a process of acquiring an operation content or the like that is output from the external connection unit 17a or the like of the television device 10. For example, the watch-over program P2 defines a process in which the communication terminal device 30 (the CPU 31) detects the operation state of a device (the television device 10 in this example) connected to the external device connection unit 32 and causes the connected device to obtain and output, in response to a user operation, a signal indicating that there has been an operation (operation notification signal) and content of the operation, for example.

In addition the watch-over program P2 defines that CPU 11 controls a process of transmitting information based on the content acquired by the external device connection unit 32 to the server device 2 by using the communication unit 33. This configuration allows the communication terminal device 30 to transmit, in response to acquiring an output from the television device 10, information based on the content of the acquired output to a watch-over server 20.

The watch-over program P2 further defines a process of setting a flag (power-on flag) indicating that the television device 10 has been powered on in the memory 35 if the acquired information output from the television device 10 in the manner as described above indicates the first power-on operation of the day. The watch-over program P2 also defines that the CPU 31 performs a process of transmitting first power-on information indicating that the television device 10 is in the power-on state for the first time on the day to the server device 2 by using the communication unit 33 together with the device identification information D1 and the user ID. The CPU 31 is able to determine whether this power-on operation is the second or subsequent power-on operation on the day depending on whether or not the power-on flag is set in the memory 35. The watch-over program P2 defines that the CPU 31 performs a process of transmitting second-or-subsequent power-on information indicating that the television device is in the power-on state for the second or subsequent time on the day to the server device 2 by using the communication unit 33 together with the device identification information D1 and the user ID if a power-on operation is performed for the second or subsequent time on the day.

The CPU 31 of the communication terminal device 30 has a clock function and detects the present date and time. The watch-over program P2 also defines that the CPU 31 performs a process of resetting the power-on flag to bring the power-on flag to the reset state if the power-on flag is set in the memory 35 when the CPU 31 determines that the date has changed as a result of the detection.

The watch-over program P2 also defines that the CPU 31 performs a process of outputting an instruction (display switching instruction) for switching the input line used for display on the display screen 10a of the television device 10 to the first external connection unit 17a to which the communication terminal device 30 is connected in order to display the first question screen 21 illustrated in FIG. 6(a) on the display screen 10a of the television device 10 after transmitting the first power-on information.

The watch-over program P2 further defines that the CPU 31 performs a process of reading question screen information (question screen information including a question which can be answered through a selection operation) corresponding to the first question screen 21 in response to acquiring the above-described information indicating that there has been a power-on operation from the watch-over-service display table T2 stored in the memory 35 and of outputting the question screen information to the television device 10. The watch-over program P2 also defines a process of measuring a period from when the question screen information of the first question screen 21 is output to when an answer selected with the first button 21a to the third button 21c included in the first question screen 21 (an answer indicating that one of the numerical buttons “1” to “3” of the remote control 19 has been pressed) is acquired from the television device 10. The watch-over program P2 further defines a comparison process of determining whether the measured period exceeds the time threshold D5 stored in the memory 35.

The watch-over program P2 defines that, in the case where the measured period does not exceed the time threshold D5 as a result of the comparison and an answer to the first question is acquired as a result of selection of one of the first button 21a to the third button 21c during that period, the CPU 31 transmits first answering state information indicating the answer based on the selected button to the server device 2 by using the communication unit 33. Further, the watch-over program P2 defines that, in the case where none of the first button 21a to the third button 21c are selected (no answer to the first question is acquired) and consequently the measured period exceeds the time threshold D1 as a result of the comparison, the CPU 31 transmits first answering state information indicating that there is no answer to the first question to the server device 2.

The watch-over program P2 defines various contents of processes for the others. For example, the watch-over program P2 defines that a process corresponding to text (e.g., Press the OK button to switch the screen to the next one) written in the bottommost bar-shaped part of FIG. 6(b) to FIG. 8(a) is to be performed. The watch-over program P2 defines that the CPU 31 performs a process of outputting screen information corresponding to the next screen of the currently displayed screen to the television device 10 upon the communication terminal device 30 acquiring information indicating that the OK button has been operated. Note that the television device 10 appropriately changes the content displayed on the display screen 10a according to the information screen output thereto so as to present various screens illustrated, for example, in FIG. 6(b) to FIG. 8(a) to the user.

In addition, the watch-over program P2 defines that the CPU 31 outputs an input line switching instruction (display switching instruction) to the television device 10 so that the screen displayed on the television device 10 is switched to a screen of a received television broadcast, upon the communication terminal device 30 acquiring information indicating that there has been an end operation, which is output from the television device 10 in response to an operation of the end button 19f of the remote control 19 in response to output of screen information (screen information that permits an end operation) corresponding to the local government home screen 23 illustrated in FIG. 7(a) to the television device 10.

In addition, as for the second question screen 26 illustrated in FIG. 8(b), the watch-over program P2 defines a process in which the communication terminal device 30 transmits second question request information to the server device 2 together with the device identification information D1 and the user ID upon acquiring information indicating that there has been an operation of the question request button 19f of the remote control 19 from the television device 10. The watch-over program P2 defines that the CPU 31 performs a process of generating, upon reception of data (such as text data) representing the second question transmitted from the server device 2, screen information corresponding to the second question screen 26 illustrated in FIG. 8(b) by using the transmitted data and of outputting the screen information to the television device 10. Note that the watch-over program 2 defines, for the displayed second question screen 26, processes similar to those for the above-described first question screen 21 illustrated in FIG. 6(a).

Further, the watch-over program P2 defines that the CPU 31 performs a process of transmitting power-off information indicating that the television device 10 is in a power-off state to the server device 2 by using the communication unit 33 together with the device identification information D1 and the user ID, upon the communication terminal device 30 acquiring information indicating that there has been a power-off operation from the television device 10.

FIG. 10 illustrates major internal components of the server device 2 of the watch-over service (the user condition checking system 1). A common server computer is employed as the server device 2 according to the embodiment. In the server device 2, various devices or the like are connected to an MPU 2a that performs overall control and various processes via an internal connection line 2h. The various devices or the like include a communication module 2b, a RAM 2c, a ROM 2d, an input interface 2e, an output interface 2f, and a mass storage system (HDD system) 2g.

The communication module 2b is a communication device corresponding to a module for connection to the network NW and is compliant with a certain communication standard (e.g., a LAN module). The communication module 2b is connected to the network NW via a certain communication device (illustration of which is omitted, corresponding to a router, for example) and enables the server device 2 to communicate with the above-described communication terminal device 30, the communication terminal A1 of the local government, and the mobile communication terminals A11 and 12 respectively used by the watching persons K11 and 12 who are neighborhood association members or local welfare officers, for example.

The RAM 2c temporarily stores contents, files, and so on related to the processes performed by the MPU 2a. The ROM 2d stores a program that defines contents of basic processes performed by the MPU 2a. The input interface 2e is an interface to which, for example, a keyboard 2i and a mouse that accept operation instructions from an operator of a cloud system for the watch-over service provided by the local government are connected. The input interface 2e transfers an operation instruction accepted from the operator to the MPU 2a. An output interface 2f is an interface to which a display 2j (display output device) is connected. The output interface 2f outputs content involving the processes performed by the MPU 2a to the display 2j so as to allow the operator to check the content of the current process or the like.

The mass storage system 2g (corresponding to a storage device) stores various databases (DBs) including data necessary for providing the watch-over service and programs, for example. Specifically, the mass storage system 2g stores a server program 3, a watch-over service program 4, a user DB 5, an answer DB 6, a second question DB 7, a registered local government DB 8, and a website table 9, for example.

The server program 3 defines various processes corresponding to a server operating system. The MPU 2a performs processes based on the defined content, whereby the server device 2 exerts a basic function as a server computer. The watch-over service program 4 will be described later. The user DB 5 and the like are described first.

FIG. 10 illustrates the overview of content of a user DB 5a of the local government A for registered users who belong to the local government A in the user DB 5. In the user DB 5a, persons who utilize the watch-over service are registered by grouping a monitored person (user) and watching persons who watch over the monitored person. The user DB 5a stores, for each user ID of the monitored person (user) that identifies one group, the name of the monitored person; the device ID (device identification information) and the communication address (a destination set when a signal and information are transmitted from the server device 2 to the communication terminal device 30) of the communication terminal device 30 connected to the television device 10 operated by the monitored person; the address, the phone number, and the email address of the monitored person; the name, the phone number, and the email address of the watching persons (corresponding to the pre-registered contact addresses); and a contract address (the phone number and the email address) of the monitoring person of the local government A in association with each other.

The server device 2 allows persons who should be notified to receive a certain notification by email, by referring to such a user DB 5a. Note that the above-described information of the user DB 5a is provided by the users who receive the watch-over service (the monitored person and the watching persons) during a preparation phase. Such provided information is registered in the user DB 5 in advance. In this way, the users can receive the watch-over service. Note that the user DB 5 stores user DBs of the other local governments, such as a user DB of a local government B and a user DB of a local government C, as well as the above-described user DB 5a of the local government A.

FIG. 11 illustrates the overview of an answer DB 6a of the local government A, indicating answering states of the registered users who belong to the local government A in the answer DB 6. The answer DB 6 is also a set of DBs indicating answers of users for each local government for each day. Accordingly, the answer DB 6 is a database in which pieces of daily information are sequentially accumulated. For example, the answer DB 6 is a set of an answer DB of the local government A from January 1 to June 6, Heisei 24 (2012); an answer DB of the local government B from January 1 to June 6, Heisei 24 (2012); an answer DB of the local government C from January 1 to June 6, Heisei 24 (2012); and so on.

FIG. 11 illustrates an answer DB 6a of the local government A on Jun. 6, 2012 in such an answer DB 6. Specifically, the answer DB 6a of the local government A stores, for each “user ID”, information corresponding to items such as the “device identification information”, the “name” of the user, the “power-on time (including a plurality of power-on times in the case where there are multiple power-on times)”, the “first answer”, the “second question”, and the “second answer” and also stores the average first power-on time at an item “average power-on time”.

Among the above-described fields of the answer DB 6a of the local government A, the “power-on time (corresponding to the power-on information and including a plurality of power-on times in the case where the power-on information is transmitted a plurality of times)”, the “first answer (corresponding to the content of the first answering state information)”, and the “second answer (corresponding to the content of the second answering state information)” store information transmitted from the communication terminal device 30 together with the reception date-and-time. An empty field indicates that no information has been transmitted by then. The “second question” indicates the type of the second question transmitted by the server device 2. Upon the server device 2 transmitting the second question, the type of the second question is stored. In addition, the average first power-on time stored at the item “average power-on time” is an average of the stored first power-on times that is calculated by the MPU 2a of the server device 2. It is assumed that the answer DB 6 stores answer DBs of other local governments such as an answer DB of the local government B and an answer DB of the local government C, as well as the above-described answer DB 6a of the local government A.

FIG. 12(a) illustrates the overview of the second question DB 7. The second question DB 7 stores four second questions (corresponding to second question candidates) in total, each for a corresponding answering state of the user (content of the first answering state information) for the first question. Specifically, the second question DB 7 stores a second question candidate 7a, a second question candidate 7b, a second question candidate 7c, and a second question candidate 7d respectively for the answers “Good”, “OK”, and “Not so good” of the first question screen 21 illustrated in FIG. 6(a) and “No answer” because the time exceeds the time threshold (timeout). Note that question contents of the second question candidates 7a to 7d are different for different answering states of the users for the first question.

For example, the second question candidate 7a is “Do you still feel good?” (including options “Good”, “OK”, and “Worse” for the answer). The second question candidate 7b is “Is there any change in your condition?” (including options “No change”, “Better”, and “Worse” for the answer). The second question candidate 7c is “Do you feel better now?” (including options “Got better”, “Little better”, and “Still not good” for the answer). The second question candidate 7d is “How are you today?” (including options “Good”, “OK”, and “Not so good” for the answer).

FIG. 12(b) illustrates the overview of the registered local government DB 8. The registered local government DB 8 is a database that stores information concerning a plurality of local governments such as the local government A, B, and C registered in the watch-over service. The registered local government DB 8 stores various kinds of information submitted by each local government when the local government is registered in the watch-over service. Information items stored in the registered local government DB 8 include the “local government ID”, the “name of the local government”, the “name of the monitoring person”, the “PW (password)”, and the “contact”. Note that the “local government ID” is identification information issued by the operating entity (the server device 2) of the watch-over service when the local government is registered in the watch-over service. In addition, names of a plurality of people can be stored at the item of the “name of the monitoring person”. Further, the “PW (password)” is information necessary for receiving the watch-over service. The password submitted by the local government when the local government is registered in the watch-over service is stored. Furthermore, at the item of the “contact”, the phone number, the email address, and the like of the monitoring person of the local government are stored (a plurality of contacts can be stored).

The website table 9 stored in the mass storage system 2g stores, for example, page data (data based on HTML, XML, or the like) constituting the webpage screens illustrated, for example, in FIGS. 13 and 14. For example, upon the URL of a website constructed by the server device 2 being accessed by the communication terminal A1 of the monitoring person K1 of the local government A, the server device 2 reads the page data of a webpage screen (homepage screen 40) illustrated in FIG. 13 from the mass storage system 2g and transmits the page data to the communication terminal A1 that has made the access. Thereafter, the server device 2 appropriately reads from the mass storage system 2g the page data corresponding to each of webpage screens 41 and 42 illustrated in FIGS. 14(a) and (b) in accordance with the operation content transmitted from the communication terminal A1 and transmits the page data to the communication terminal A1. Note that the website table 9 also stores various kinds of page data other than that of the webpage screens illustrated in FIGS. 13 and 14.

The homepage screen 40 illustrated in FIG. 13 is a homepage screen of a website provided to the monitoring person of each local government by the watch-over service. The homepage screen 40 includes a local government ID input field 40a, a PW (password) input field 40b, and a login button 40c.

In addition, the condition list screen 41 illustrated in FIG. 14(a) includes a table 41a that lists current conditions of the monitored persons who belong to the local government that has logged in on the homepage screen 40. This table 41a is created by the MPU 2a of the server device 2 by using the information included in the latest answer DB for the logged-in local government from the above-described answer DB 6. Each name included in the table 41a is selectable.

FIG. 14(b) illustrates the detail screen 42 for the monitored person having the name selected at the table 41a of the condition list screen 41. This detail screen 42 is a screen which is displayed/output from the condition list screen 41. The power-on times based on the power-on information for a plurality of days (e.g., one week) of the monitored person selected on the condition list screen 41 are read from the above-described answer DB 6. A horizontal bar graph 42a which is generated by the MPU 2a of the server device 2 based on the read information is arranged.

The watch-over service program 4 of the server device 2 will be described next. The watch-over service program 4 corresponds to a computer program for a server computer and defines various processes performed by the MPU 2a in order to provide the watch-over service. The watch-over service program 4 according to the embodiment mainly defines two processes. The first one is related to a process of creating and accumulating the above-described answer DB 6 as needed, and the second one is related to a process of providing the accumulated information to the monitoring person of each local government via a webpage.

As content of the first process of the watch-over service program 4, a process of storing, upon receipt of power-on information transmitted from the communication terminal device 30, the power-on information in the above-described answer DB 6 together with the reception date-and-time is defined. At this time, the MPU 2a refers to the device identification information D1 and the user ID that accompany the power-on information, and stores the power-on information at the item “power-on time” in association with a corresponding user ID in the answer DB 6.

The watch-over service program 4 also defines a process of determining whether the received power-on information is the first power-on information of the day or the second-or-subsequent power-on information. The watch-over service program 4 defines a process of, if the received power-on information is the first power-on information, receiving answering state information (such as first answering state information) transmitted from the communication terminal device 30 thereafter and storing the content of the received answering state information at the item “first answer” of the above-described answer DB 6 together with the reception date-and-time of the answering state information. At this time, the MPU 2a refers to the device identification information D1 and the user iD that accompany the above-described first power-on information and stores the content of the received answering state information in association with the corresponding user ID in the answer DB 6.

The watch-over service program 4 also defines that the MPU 2a performs, after storing the content of the answering state information, a process of reading information stored at the item “first answer” for the last multiple days (e.g., five days) associated with the received user ID from the above-described answer DB 6 and transmitting answer history information to the communication terminal device 30 that has made the access. Note that the watch-over service program 4 does not particularly define a process to be performed if the received power-on information is the second-or-subsequent power-on information. Accordingly, the MPU 2a enters a state for waiting to receive power-off information.

In addition, the watch-over service program 4 defines that the MPU 2a stores, upon receipt of power-off information transmitted from the communication terminal device 30 together with the device identification information D1 and the user ID after transmitting the answer history information or receiving the second-or-subsequent power-on information, the power-off information at the item “power-off time” together with the reception time of the power-off information in association with the corresponding user ID in the answer DB 6 by referring to the device identification information D1 and the user ID. As a result of the watch-over service program 4 defining the above-described processes, the power-on time and the power-off time of the day are sequentially accumulated at the item “power-on time” of the answer DB 6. This consequently allows the monitoring person to remotely confirm that the monitored person is well enough to watch the television device 10.

As for the second question screen 26 illustrated in FIG. 8(b), the watch-over service program 4 defines a process of selecting, upon receipt of second question request information transmitted from the communication terminal device 30 together with the device identification information D1 and the user information D4, a second question corresponding to the content (of the first answering state information) stored at the item “first answer” associated with the user ID of the received user information D4 in the answer DB 6 from among the second question candidates 7a to 7d that are stored in the second question DB 7 illustrated in FIG. 12(a). The watch-over service program 4 also defines that the selected type of the second question (the second question candidate) is stored at the item “second question” of the answer DB 6.

The watch-over service program 4 defines that the MPU 2a performs a process of reading the selected second question candidate from the second question DB 7 and transmitting, as the second question, the read second question candidate to the communication terminal device 30 that has transmitted the second question request information. The watch-over service program 4 also defines that the MPU 2a performs a process of storing, upon receipt of second answering state information for the second question from the communication terminal device 30 together with the device identification information D1 and the user ID, the content of the second answering state information at the item “second answer” of the answer DB 6 together with the reception date-and-time in association with the corresponding user ID in the answer DB 6. As a result of the watch-over service program 4 defining the above-described processes, the content of the first answer (first answering state information) and the content of the second answer (second answering state information) transmitted from the monitored person are sequentially accumulated in the answer DB 6 together with the date and time at which the answer was made. Accordingly, the information stored at the items “first answer” and “second answer” allows the monitoring person to remotely estimate/grasp the feeling/physical condition of the monitored person. Note that if information (e.g., a notification indicating that an unusual situation has occurred to the user) other than the above-described kinds of information is received, such information is also stored in the answer DB 6 together with the reception date-and-time in association with the corresponding user ID as in the above-described case.

As content of the second process of the watch-over service program 4, a process of transmitting page data corresponding to the homepage screen 40 illustrated in FIG. 13 to the accessing entity when the URL of a webpage is accessed is defined, in order to provide the information accumulated in the above-described answer DB 6 to the monitoring person of each local government.

The watch-over service program 4 also defines a process of determining, upon receipt of a local government ID and a password transmitted from the accessing entity in response to transmission of the page data, whether there are a local government ID and a password that match the received local government ID and the received password in the registered local government DB 8 illustrated in FIG. 12(b). The watch-over service program 4 defines that the MPU 2a performs a process of transmitting, if either the received local government ID or the received password does not match the one stored in the registered local government DB 8, page data of a webpage including a message prompting re-entry of the local government ID and the password to the accessing entity.

The watch-over service program 4 defines that the MPU 2a performs a process of identifying, if the received local government ID and the received password match the ones stored in the registered local government DB 8, an answer DB (the latest one) of the local government having the matching local government ID from the answer DB 6 and identifying a situation from among “watched TV within 3 hours”, “watched TV within 24 hours”, “watched TV yesterday”, and “not watched TV for 2 days” on the basis of the information stored at the item “power-on time” of the answer DB of the identified local government by referring to the current date and time.

The watch-over service program 4 defines that the MPU 2a then performs a process of transmitting/outputting, to the accessing entity, the content of the identified situation in association with the information read from the items “name” and “first answer” of the answer DB of the local government. As a result of this process, the condition list screen 41 illustrated in FIG. 14(a) is displayed on the communication terminal A1 of the monitoring person K1 of the local government A, for example.

The watch-over service program 4 further defines a process of reading, upon receipt of the user ID (user information D4) of a person selected at the table 41a of the condition list screen 41 of FIG. 14(a) from the accessing entity, information concerning the power-on time associated with the user ID for the last multiple days (e.g., one week) from the item “power-on time” of the answer DB 6, generates an image representing the information as a horizontal bar graph, and transmitting/outputting, to the accessing entity, the generated image data. As a result of this process, the detail screen 42 illustrated in FIG. 14(b) is displayed on the communication terminal A1 of the monitoring person K1 of the local government A, for example.

The watch-over service program 4 defines a process of allowing webpage screens other than the above ones to be displayed on the communication terminal A1 of the monitoring person K1. For example, the watch-over service program 4 defines a process of reading, upon receipt of information indicating that a detail button 42b has been selected on the detail screen 42 from the accessing entity, information stored at the items “first answer”, “second question”, and “second answer” from the answer DB 6 and transmitting the information to the accessing entity. As a result of this process, the monitoring person K1 can check the various kinds of information stored in the answer DB 6 in association with the monitored person from various viewpoints and can use such information in determining whether it is necessary to visit the monitored person. These various webpage screens can be displayed not only on the communication terminal A1 of the monitoring person K1 of the local government but also on the mobile terminal devices A11 and 12 owned by neighborhood association members or local welfare officers if the local government ID and the password match. Obviously, such webpage screens can be displayed on the display 2j of the server device 2.

Note that, it has been described above that the watch-over service program 4 includes the above-described two processes; however, the first process and the second process described above may be defined by separate programs and these separate programs may be used. In addition, it has been described above that a single server device 2 performs the various processes; however, obviously, a server device system including a plurality of server devices may be constructed and the various processes may be performed in a distributed manner.

FIG. 15 to FIG. 18 are a first flowchart to a fourth flowchart that illustrate a time-based procedure (corresponding to a procedure indicating the content of the user condition checking method or the user condition notification method) of the above-described various processes performed by the user condition checking system 1. Based on the first flowchart to the fourth flowchart, a procedure of a series of various processes collaboratively performed by the communication terminal device 30 connected to the television device 10 and the server device 2 will be described below.

The first flowchart of FIG. 15 to the third flowchart of FIG. 17 mainly illustrate the procedure of the process in which the server device 2 collects and accumulates information indicating the condition of the monitored person. The first flowchart starts when the television device 10 is in the power-off state. First, in response to a power-on operation performed on the television device 10 by the user, the communication terminal device 30 determines whether information indicating that there has been a power-on operation is acquired from the television device 10 (S1). If information indicating there has been a power-on operation is not acquired (S1: NO), the communication terminal device 30 enters a state for waiting for a power-on operation performed by the user. If information indicating that there has been a power-on operation is acquired (S1: YES), the communication terminal device 30 determines whether this power-on operation is the first power-operation on the day on the basis of whether the power-on flag in the memory 35 is set (S2). If it is determined that this power-operation is not the first power-on operation (S2: NO), the communication terminal device 30 transmits the second-or-subsequent power-on information to the server device 2 together with the device identification information D1 and the user ID (S3). In this case, the process proceeds to “C” of the second flowchart of FIG. 16.

If it is determined that this power-on operation is the first power-on operation (S2: YES), the communication terminal device 30 sets the power-on flag in the memory 35 and transmits the first power-on information to the server device 2 together with the device identification information D1 and the user ID (S4).

Upon receipt of the (first or second-or-subsequent) power-on information from the communication terminal device 30, the server device 2 performs a process of storing the received power-on information at the item “power-on information” of the answer DB of the corresponding local government (e.g., the answer DB 6a of the local government A) included in the answer DB 6 together with the reception date-and-time in association with the user ID received therewith (S11). Then, the server device 2 determines whether the received power-on information is the first power-on information (S12). If the received power-on information is not the first power-on information (S12: NO), the process performed by the server device 2 proceeds to processing of “D” of the second flowchart of FIG. 16. If the received power-on information is the first power-on information (S12: YES), the server device 2 enters a state for waiting to receive next information (first answering state information).

The process then returns to the one related to the television device 10. After step S4, the communication terminal device 30 outputs a display switching instruction in order to switch the input line of the television device 10 to the first external connection unit 17a, reads question screen information corresponding to the first question screen 21 illustrated in FIG. 6(a) from the memory 35, and outputs the question screen information to the television device 10 (S5). Consequently, the first question screen 21 is displayed on the display screen 10a of the television device 10. Note that the communication terminal device 30 starts measuring a period from the output of the question screen information corresponding to the first question screen 21. The communication terminal device 30 then determines whether an answer is acquired from the television device 10 as a result of an operation of selecting one of the first button 21a to the third button 21c arranged on the first question screen 21 (S6). If one of the answers is acquired (S6: YES), the communication terminal device 30 transmits the first answering state information (first answer) indicating the acquired answer to the server device 2 (S7).

If none of the answers are acquired (S6: NO), the communication terminal device 30 determines whether the measured period has exceeded the time threshold D5 and a timeout has occurred (S8). If a timeout has not occurred (S8: NO), the process returns to step S6. If a timeout has occurred (S8: YES), the communication terminal device 30 transmits first answering state information indicating that there is no answer to the first question to the server device 2 (S9). In response to the timeout of the measured period, the communication terminal device 30 resets the measured period (the same applies to the following).

If the server device 2 which is in the state for waiting to receive the next information receives the first answering state information based on the first answer transmitted in step S7 or the first answering state information indicating no answer to the first question transmitted in step S9, the server device 2 performs a process of storing, in association with the reception date-and-time, the received first answering state information at the item “first answer” associated with the same user ID in the answer DB for the same local government used in step S11 (S13).

Then, as illustrated in the second flowchart of FIG. 16, the server device 2 performs a process of reading the first state information associated with the user ID from the item “first answer” of the answer DB of the local government for the last five days together with the reception date-and-time, creating answer history information for the last five days, and transmitting the answer history information to the communication terminal device 30 (S14).

Upon receipt of the answer history information, the communication terminal device 30 generates the answer screen 22 illustrated in FIG. 6(b) including the received answer history information by using the display part data read from the memory 35 and outputs screen information corresponding to the generated answer screen 22 to the television device 10 (S20). As a result, the answer screen 22 is automatically displayed on the display screen 10a of the television device 10, which allows the monitored person M1 to check their conditions for the last five days.

After outputting the answer screen 22, the communication terminal device 30 determines whether information indicating that the OK button 19b has been operated is acquired from the television device 10 as a result of the user operating the OK button 19b of the remote control 10 (S21). If the OK button 19g has not been operated (S21: NO), the process returns to step S20. If information indicating that the OK button 19g has been operated is acquired (S21: YES), the communication terminal device 30 accesses a website provided by the local government service providing system illustrated in FIG. 1 to obtain the menu content or the like of the homepage of the website, generates the local government home screen 23 illustrated in FIG. 7(a) by using the acquired menu content and the display part data read from the memory 35, and outputs screen information corresponding to the generated local government home screen 23 (screen information that permits an end operation) to the television device 10 (S22). Consequently, the local government home screen 23 is displayed on the display screen 10a of the television device 10.

Then, upon receipt of information indicating that any of the numerical buttons 20 or the back button of the remote control 19 has been operated from the television device 10, the communication terminal device 30 outputs various screen information corresponding to the life-related information screen 24 illustrated in FIG. 7(b), the neighborhood association information screen 25 illustrated in FIG. 8(a), or the like to the television device 10 (S23) so as to display the appropriate screen 23, 24, 25, or the like, on the display screen 10a of the television device 10. Then, the communication terminal device 30 determines whether information indicating that the end button 19h of the remote control 19 has been operated is acquired from the television device 10 which displays the local government home screen 23 or the like (S24). If information indicating that the end button 19h has been operated is not acquired (S24: NO), the process returns to step S22.

If information indicating that the end button 19h has been operated is acquired (S24: YES) or if the second-or-subsequent power-on information is transmitted (S3) in the first flowchart of FIG. 15, the communication terminal device 30 then outputs to the television device 10 an instruction (display switching instruction) to switch the input line of the television device 10 to the line of the preprocessing unit 11 including the tuner unit and the like illustrated in FIG. 3, so that the content displayed on the display screen 10a of the television device 10 is switched to the screen of the received television broadcast (S25). Upon receipt of such a display switching instruction, the television device 10 receives a broadcast signal of the last channel (the latest turned channel) and displays the broadcast video image of the channel on the display screen 10a.

Then, the communication terminal device 30 determines whether information indicating that the user has performed a power-off operation is acquired from the television device 10 (S26). If a power-off operation has not been performed (S26: NO), the process returns to step S25. If information indicating that there has been a power-off operation is acquired (S26: YES), the communication terminal device 30 transmits the power-off information to the server device 2 together with the device identification information D1 and the user ID (S27). After transmitting the power-off information, the television device 10 stops the operation thereof and enters a power-on standby state; however, the communication terminal device 30 is not powered off but enters a state for waiting to acquire information indicating that there has been a power-on operation output from the television device 10.

Upon receipt of the power-off information transmitted from the communication terminal device 30, the server device 2 performs a process of storing, in association with the user ID received together, the received power-off information at the item “power-on information” of the answer DB of the corresponding local government (e.g., the answer DB 6a of the local government A) in the answer DB 6 together with the reception date-and-time (S15). In a configuration in which display of the local government home screen 23 is prioritized, after the step of transmitting the second-or-subsequent power-on information in the first flowchart of FIG. 15 (S3), the process may proceed to the step of outputting the screen information corresponding to the local government home screen 23 (S22) instead of the step of displaying the broadcast video image of the last channel (S25). In addition, a step of determining whether information indicating that the “BACK” button has been operated is acquired may be provided between the step of outputting the screen information corresponding to various screens (S23) and the step of determining operation of the end button (S24). If the information indicating that the operation has been performed is acquired, the process may return to the step of outputting the screen information corresponding to the local government home screen 23 (S22). In this case, if an operation of the “END” button is not acquired in step S24 (S24: NO), the process returns to the step of outputting the screen information corresponding to the various screens (S23).

In the third flowchart of FIG. 17, the communication terminal device 30 determines whether information indicating that the question request button 19f of the remote control 19 has been operated by the user is acquired when the broadcast video image is displayed on the television device 10 as a result of the above-described processing of step S25 of the second flowchart of FIG. 16 (S30). If information indicating that the question request button 19f has been operated is not acquired (S30: NO), the communication terminal device 30 enters a state for waiting for the operation. If information indicating that the question request button 19f has been operated is acquired (S30: YES), the communication terminal device 30 transmits the second question request information to the server device 2 together with the device identification information D1 and the user ID (S31).

Upon receipt of the second question request information, the server device 2 selects a second question that corresponds to the content stored at the item “first answer” associated with the received user ID in the answer DB 6 from among the second question candidates 7a to 7d stored in the second question DB 7 illustrated in FIG. 12(a) and transmits the selected second question to the communication terminal device 30 (S16). At that time, the server device 2 stores the type of the selected second question at the item “second question” of the answer DB 6.

Upon receipt of the second question transmitted from the server device 2, the communication terminal device 30 generates the second question screen 26 illustrated in FIG. 8(b) by using the second question and outputs screen information corresponding to the generated second question screen 26 to the television device 10 (S32). As a result of this output, the television device 10 displays the second question screen 26 that surrounds the broadcast video image in an L-shape. The subsequent process is similar to that of the case of outputting the screen information corresponding to the first question screen 21 in the first flowchart of FIG. 15, and thus the detailed description is omitted. The communication terminal device 30 performs processing of steps S34 to S36 of FIG. 17, whereas the server device 2 performs processing of step S17. Through the above-described process, information concerning the monitored person is sequentially accumulated in the answer DB 6 of the server device 2.

A fourth flowchart of FIG. 18 illustrates a procedure of a process allowing the monitoring person of the local government to view, by using the communication terminal A1, information concerning the monitored persons accumulated in the answer DB 6 of the server device 2 so as to check the conditions of the monitored persons. First, the monitoring person K1 accesses, by using the communication terminal A1, the URL of the website of the watch-over service provided by the server device 2 (S50). The server device 2 determines whether the URL is accessed (S40). If the URL is not accessed (S40: NO), the server device 2 enters a state for waiting for an access. If the URL is accessed (S40: YES), the server device 2 transmits/outputs page data corresponding to a homepage screen 30 illustrated in FIG. 12 to the communication terminal A1 of the monitoring person K1, which serves as an accessing entity (S41).

Upon receipt of the page data corresponding to the homepage screen 30, the communication terminal A1 displays/outputs the homepage screen 30 (S51). Then, the communication terminal A1 determines whether the monitoring person K1 has operated a login button 31c after entering the local government ID and the password (S52). If the login button 31c has not been operated (S52: NO), the communication terminal A1 enters a state for waiting for the operation of the login button 31c. If the login button 31c has been operated (S52: YES), the communication terminal A1 transmits the local government ID and the password to the server device 2 (S53).

Upon receipt of the local government ID and the password, the server device 2 determines whether the registered local government DB 8 illustrated in FIG. 11(b) includes a local government ID and a password that respectively match the received local government ID and password (S42). If the received local government ID and password do not match the ones stored in the registered local government DB 8 (S42: NO), the process returns to step S41, and the server device 2 transmits/outputs, to the communication terminal A1, page data corresponding to the homepage screen 30 indicating that the local government ID and the password do not match.

If the received local government ID and password match the ones stored in the registered local government DB 8 (S42: YES), the server device 2 identifies the answer DB (the latest one) of the local government indicated by the matching local government ID from the answer DB 6 and determines the TV watching state of “watched TV within 3 hours”, “watched TV within 24 hours”, “watched TV yesterday”, or “not watched TV for 2 days”. The server device 2 then generates a condition list screen 31 illustrated in FIG. 13(a), which includes the determined state and information stored at the items “name” and “first answer” of the answer DB of the local government and transmits/outputs the page data to the communication terminal A1 (S43).

The communication terminal A1 receives the page data and displays/outputs the condition list screen 31 (S54). This allows the monitoring person using the communication terminal A1 to check the conditions of a plurality of monitored persons for the day at a glance. Then, the communication terminal A1 determines whether a monitored person has been selected from a table 31a of the condition list screen 31 by an operation performed by the monitoring person K1 (S55). If no monitored person is selected (S55: NO), the communication terminal A1 enters a state for waiting for selection. If a monitored person is selected (S55: YES), the communication device A1 transmits the user ID (user information D4) of the selected monitored person to the server device 2 (S56).

Upon receipt of the user ID (user information D4), the server device 2 reads the power-on times for a plurality of days (e.g., one week) associated with the user ID from the item “power-on time” of the answer DB 6 and transmits/outputs, to the communication terminal A1, page data of a detail screen 32 illustrated in FIG. 13(b) and including an image representing the power-on times as a horizontal bar graph (S44).

Upon receipt of the page data, the communication terminal A1 displays/outputs the detail screen 32 (S57). Through such a processing procedure, the monitoring person K1 determines whether there is a person who needs to be visited from among the plurality of monitored persons by viewing the condition list screen 31 and the detail screen 32. If the monitoring person K1 determines that there is a person who needs to be visited, the monitoring person K1 communicates with the watching person K11 or K12 who is a neighborhood association member or a local welfare officer illustrated in FIG. 1 by telephone or email to request the watching person to visit the person. In response to the request, the watching person K11 or K12 visits the monitored person to directly check the condition of the monitored person.

The present invention enables, through the above-described processes, without providing any special sensors, details about the monitored person to be transmitted to and accumulated in the server device 2 via the communication terminal device 30 by using the display function of a display device, such as the television device 10 which the monitored person uses daily, thereby allowing the monitoring person K1 to remotely check the condition of the monitored person. Thus, the system can be constructed much more inexpensively and easily than the systems of the related art, and details about the monitored person can be grasped more accurately.

It should be noted that the present invention is not limited to the above-described embodiment, various modifications may occur. For example, in addition to the above-described direct connection, obviously, the television device 10 and the communication terminal device 30 may be connected using a cable such as a connection cable or wirelessly. Further, the standard used for connection is not limited to HDMI (registered trademark), and any of the standard for wired LAN, the standard for wireless LAN, Bluetooth, infrared communication (IrDa), Zigbee (registered trademark), USB, NFC (a type of short-range wireless communication standard), TRANSFERJET (registered trademark), and the like may be employed. In addition, the communication terminal device 30 may have a box-like shape or a plate-like shape as well as a stick-like shape.

Further, the communication terminal device 30 may be configured to detect the current input line of the television device 10. If the detection result indicates the first external connection unit 17a to which the communication terminal device 30 is connected, the communication terminal device 30 may be configured not to output the display switching instruction to the television device 10 in the step of outputting the screen information in step S5 of the first flowchart of FIG. 15 or the like. The communication terminal device 30 may be configured to output the display switching instruction only when the detection result indicates an input line other than the first external connection unit 17a to which the communication terminal device 30 is connected.

In addition to the form of the first question screen illustrated in FIG. 6(a), a first question screen 50 including, for example, local government information 50c as information (notification information) provided by the server device 2 may be used as indicated by a modification in FIG. 19. In order to display the first question screen 50 according to such a modification, the server device 2 acquires the latest notification information by crawling through the local government service providing system and the other information providing systems illustrated in FIG. 1 and stores the latest notification information in the mass storage system 2g. Upon receipt of the power-on information from the communication terminal device 30, the server device 2 reads the latest notification information to be provided and transmits the latest notification information to the communication terminal device 30. The communication terminal device 30 generates screen information for arranging the received notification information in the read first question screen and outputs the screen information to the television device 10. In this way, the first question screen 50 according to the modification illustrated in FIG. 19 can be presented to the monitored person.

This first question screen 50 includes information that is useful for the user and thus is advantageous in that it can increase the motivation to carefully watch the first question screen. In addition, the first question screen 50 includes a first button 50a and a second button 50b for the answer to the first question. These buttons 50a and 50b are respectively associated with the blue button 19b and the red button 19c of the remote control 19.

Further, in another modification, as the first question included in the first question screen 21 illustrated in FIG. 6(a), a question stored in the server device 2 may be used instead of a question stored in the communication terminal device 30. In this case, the server device 2 stores a plurality of first question candidates in the mass storage system 2g in advance. These first question candidates are associated with search tags, such as the season, the time slot, a day of the week, a health condition, or the like. Upon receipt of the power-on information from the communication terminal device 30, the server device 2 performs a process of performing a search on the plurality of first question candidates by using the season or the time slot at the time of reception, reading a retrieved one as the first question, and transmitting the first question to the communication terminal device 30.

Upon receipt of the first question, the communication terminal device 30 generates a first question screen including the received first question and outputs screen information corresponding to the generated first question screen to the television device 10. In such a modification, because the content of the question given to a monitored person changes appropriately, the monitored person is asked different questions every day. Such a configuration is advantageous in that it can prevent the monitored person from getting tired of the question. Note that, in this modification, a plurality of kinds of the second question DB 7 illustrated in FIG. 12(a) are also prepared for types of answers to the stored first question candidates.

In addition, arranging the above-described notification information in the question screen can be applied to the second question screen 26 of FIG. 8(b). Further, the second question screen including such notification information may be displayed in the following manner. Upon finding the latest notification information, the server device 2 transmits page data of the second question screen to the communication terminal device 30. The communication terminal device 30 outputs screen information corresponding to the page data to the television device 10 so as to display the second question screen including the latest information on the television device 10. This configuration allows the second question screen to be displayed together with the broadcast video image which the monitored person is watching, not only in the case where the monitored person has operated the question request button 19f of the remote control 19 but also in the case where information which the monitored person should be notified of is found, enabling timely presentation of the second question. Note that the second question screen can be displayed together with the broadcast video image in a manner of so-called picture-in-picture or picture-out-picture. Further, the second question screen may be displayed in the same manner as the first question screen by switching the input line from broadcast video.

Further, go-out buttons such as “go out all day today”, “go out for 2 days from tomorrow”, and “go out for 3 days from the day after tomorrow” may be provided on the first question screen or the second question screen in a selectable manner. If one of these buttons is selected, content associated with the selected go-out button may be output to the communication terminal device 30. Upon acquiring such content, the communication terminal device 30 may perform a process of transmitting the content to the server device 2. In this case, the server device 2 stores the transmitted information such as the number of days for which the monitored person goes out at the item “going out schedule” of the answer DB 6 together with the reception date-and-time. In this way, the situation can be avoided in which the case where the monitored person is just away is falsely determined that the monitored person is so ill that the monitored person cannot power on the television device 10.

The format of the condition list screen 41 illustrated in FIG. 14(a) and the format of the detail screen 42 illustrated in FIG. 14(b) are merely examples, and screens including various kinds of information contained in the answer DB 6 can be used in accordance with the specifications of the system and the requests of the local government. For example, the format of a condition list screen 51 illustrated in FIG. 20(a) and the format of a detail screen 52 illustrated in FIG. 20(b) may be employed.

In addition, content of the condition list screen or the detail screen may be transmitted to the monitoring person K1 by email. For example, in the case where the monitoring person K1 has not viewed the content for a certain period, the server device 2 may transmit an email to the communication terminal A1 of the monitoring person K1. Content of the email may be content such as “Mr. Ao Akasaka has answered “woke up feeling good” at 7:15 today” or “Dear the monitoring person of the local government A. We have not received the condition of Ms. Ako Yamashita at 9:38 today”. Note that, as illustrated in FIG. 21, an email 53 including content equivalent to that of the condition list screen 41 of FIG. 14(a) may be used. Further, a configuration can be made to transmit such an email on a regular basis. For example, an email may be transmitted from the server device 2 to the communication terminal A1 of the monitoring person at 9 in the morning everyday.

In addition, the television device 10 may be equipped with a videophone function by using the communication function of the communication terminal device 30. In this case, the condition can be checked by a videophone call before the neighborhood association member or the local welfare officer visits the monitored person. Further, the display device used by the monitored person is not limited to the television device 10. Various display devices can be used as long as the display devices can be connected to the communication terminal device 30 and have the display function. For example, a display device used for a desktop personal computer, a digital photoframe device that displays photographs and images, a tablet device capable of displaying various kinds of information, and the like can be employed.

Further, the description has been given of the case where the first question includes a single question on the first question screen 21 illustrated in FIG. 6(a) described above; however, obviously, a plurality of questions may be included in the first question. In such a case, for example, a question Q1 and a question Q2 are listed on the first question screen, and a plurality of answers are arranged for each question with checkboxes so as to allow the user to check, for each question, a checkbox of their answer. By including a plurality of questions in the first question in this way, the user's physical condition and feeling can be checked in more detail, which is preferable. Providing a plurality of questions may be obviously applied to the second question (second question candidate).

In the case of providing a plurality of questions in the first question (or the second question), some of the plurality of questions may be stored in the server device 2 and the rest of the plurality of questions may be stored in the communication terminal device 30, and the first question (or the second question) may be generated by the communication terminal device 30 by combining these questions and may be output to the television device 10. In this case, upon receipt of the power-on information, the server device 2 reads some of the stored questions and transmits the read questions to the communication terminal device 30. Upon receipt of the questions, the communication terminal device 30 reads some of the stored questions, generates screen information corresponding to the first question (or the second question) by combining the read questions and the received questions, and outputs the screen information to the television device 10.

In this modification, the content of the questions stored in the server device 2 can be changed in a given manner by the server device. Thus, the first question (or the second question) provided to the user is constituted by questions whose content changes in a given manner and questions whose content is fixed, making the variation of content of the question to the user wider. This is useful to check the condition (such as the physical condition and feeling of the user) of the user in detail.

Further, in the description above, the second question screen is output at a certain interval from the first question screen; however, the second question screen may be automatically output after the user completes answering the first question. In this case, if the user (monitored person) presses the “OK” button on the answer screen 22 illustrated in FIG. 6(b) after answering the first question, the communication terminal device 30 acquires information indicating that the OK button has been operated. Upon acquisition of this information, the communication terminal device 30 transmits the second question request information indicating an inquiry about “Is there a second question?” to the server device 2. Upon receipt of the second question request information, the server device 2 determines whether there is a second question to be provided among those stored therein. If there is a second question, the server device 2 transmits the second question to the communication terminal device 30. Consequently, the communication terminal device 30 can output screen information corresponding to the second question screen to the television device 10 subsequent to the first question screen. If there are a third question and a fourth question after the second question, screen information corresponding to the third question and the like may be sequentially output to the television device 10 subsequent to the second question in the above-described processing flow.

In addition, as for a timeout (a period exceeding the time threshold) in answering the first question or the second question, the time threshold is stored in the communication terminal device 30 and the communication terminal device 30 determines whether a timeout has occurred in the description above; however, the time threshold may be stored in the server device 2 and the server device 2 may determine whether a timeout has occurred. In this case, the server device 2 is configured to transmit the first question. The server device 2 measures a period from the transmission of the first question. If the server device 2 receives the first answering state information transmitted from the communication terminal device 30 before the measured period exceeds the stored time threshold, the server device 2 performs a process of storing the received first answering state information. If the measured period has exceeded the time threshold before the server device 2 receives the first answering state information, the server device 2 stores the first answering state information indicating no answer to the first question.

Further, as the notification information included in the first question screen 50 illustrated in FIG. 19, not only information transmitted from the server device 2 but also information uniquely acquired by the communication terminal device 30 from an external information providing system or the like may be used. Furthermore, the first question screen can be displayed on the display screen 10a together with a broadcast video image of a television broadcast, just like the second question screen 26 illustrated in FIG. 8(b). Display examples of this case include an arrangement in which the first question and the broadcast video image are displayed side by side, an arrangement in which the broadcast video image is displayed in the first question in a picture-in-picture manner, and an arrangement in which the first question is displayed in the broadcast video image in a picture-in-picture manner.

In addition, screens of various questions or like may be displayed on the television device 10 by using various display user interfaces such as OSD, a web browser, and a widget (the use of a module or an application is also possible). Accordingly, a suitable display method may be employed in accordance with requirements of the system specifications or device specifications. Further, a plurality of display methods may be used in combination. For example, the first question may be displayed using a browser, and the second question may be display using OSD.

Further, in the description above, it is determined that whether this power-on operation is the first power-on operation or the second-or-subsequent power-on operation on the basis of the power-on flag stored in the memory 35 of the communication terminal device 30; however, the server device 2 may count the number of times the power-on information is transmitted, determine the number of times of power-on, and transmit the determined result to the communication terminal device 30. In the case where the server device 2 determines the number of times of power-on in this way, the server device 2 may be configured to transmit the first question to the communication terminal device 30 if this power-on operation is the first power-on operation and transmit the local government home screen if this power-on operation is the second or subsequent power-on operation. Such a configuration can also be employed.

In addition, the user condition checking system 1 according to the present invention is obviously applicable to services other than the watch-over service provided by the local government. For example, the system can be constructed such that, for example, for a parent and a child who live separately, the parent is set as a monitored person and the child is set as a monitoring person and a watching person. Further, in addition to transmitting information concerning the conditions of the users (such as content of the condition list screen and the detail screen) to the monitoring person K1 of the local government, the server device 2 may transmit it directly to the mobile communication terminals of the watching persons K11 and K12 depending on the configuration of the user condition checking system 1. In such a case, it is preferable to transmit the information by email (see FIG. 21 or the like); however, obviously, a configuration in which necessary information is transmitted via a website in response to an access from the watching person K11 or K12 can be also employed.

### Second Embodiment

FIG. 22 is a fifth flowchart according to a second embodiment of the present invention. This fifth flowchart illustrates a processing procedure that is alternatively used in steps subsequent to step S9 of the first flowchart of FIG. 15. The second embodiment is characterized in that the first question screen 21 is repeatedly presented to the user if an answer from the user is not acquired on the first question screen 21. The basic hardware configuration or the like of the second embodiment is similar to that of the first embodiment. Thus, the second embodiment will be described below by using the same reference signs as those used in the first embodiment for the similar parts.

Contents defined by the watch-over program P2 stored in the memory 35 of the communication terminal device 30 of the second embodiment include the process of the fifth flowchart illustrated in FIG. 22. In addition, the memory 35 stores a number-of-times threshold which is used in the process of the fifth flowchart. The number-of-times threshold indicates the number of times of repetition, and is set to 5 times by default; however, the threshold can be set to a desired value in a range from 1 to an infinite number through a setup menu not illustrated.

The processing procedure of the second embodiment will be described next with reference to the fifth flowchart. In the second embodiment, processing is performed in a similar manner up to step S9 of the first flowchart of FIG. 15. Note that step S9 is a step of transmitting, to the server device 2, the first answering state information indicating that no answer is acquired upon the elapsed period exceeding the time threshold (S8: YES) before the communication terminal device 30 acquires an answer to the question from the television device 10 in step S8. After step S9, the communication terminal device 30 outputs, to the television device 10, a display switching instruction (first display switching instruction) for switching the input line so that the screen of a received television broadcast is displayed on the display screen 10a (S60). The communication terminal device 30 then performs a process of incrementing a number-of-times count by 1 (S61), stores the current count in the memory 35, and determines whether the current count has exceeded the number-of-times threshold stored in the memory 35 (S62).

Upon determining that the current count has not exceeded the number-of-times threshold (S62: NO), the communication terminal device 30 counts for a certain period (e.g., 5 seconds) (S63). The process then returns to step S5 of the first flowchart of FIG. 15, in which the communication terminal device 30 outputs, to the television device 10, a display switching instruction (second display switching instruction) for switching the input line to the first external connection line 17a, reads the question screen information corresponding to the first question screen 21 illustrated in FIG. 6(a) from the memory 35, and outputs the question screen information to the television device 10 (S5). As a result of the process returning to step S5 in this way, the first question screen 21 is re-displayed on the television device 10.

After the process returns to step S5, the communication terminal device 30 and the server device 2 perform processing subsequent to step S5 as in the first embodiment; however, after step S9, the process proceeds to step S60 of the fifth flowchart illustrated in FIG. 22. Accordingly, if the communication terminal device 30 does not acquire any answer to the first question included in the first question screen 21, the screen of the received television broadcast is re-displayed on the display screen 10a. In order to perform such re-display, the step in which the communication terminal device 30 outputs, to the television device 10, a display switching instruction (first display switching instruction) for switching the input line (S60) and the step in which the communication terminal device 30 outputs, to the television device 10, a display switching instruction (second display switching instruction) for switching the input line to the first external connection unit 17a so that the first question screen 21 is displayed on the display screen 10a of the television device 10 are sequentially repeated.

If it is determined that the current count has exceeded the number-of-times threshold as a result of repetition of the above process (S62: YES), the communication terminal device 30 transmits a “notification indicating that an unusual situation has occurred to the user” to the server device 2 (S64). After the transmission of the “notification indicating that an unusual situation has occurred to the user”, the process performed by the communication terminal device 30 ends.

Upon receipt of the notification indicating that “an unusual situation has occurred to the user”, the server device 2 stores the notification in the answer DB 6 together with the reception date-and-time. Further, the server device 2 receives the device identification information D1 and the user ID which are transmitted from the communication terminal device 30 together with the notification, identifies the email address corresponding to the communication terminal A1 used by the monitoring person K1 associated with the received user ID in the user DB 5, and automatically creates and transmits an email including an instruction (fixed text) indicating that it is necessary to immediately visit the monitored person to the identified email address. The watch-over service program 4 according to the second embodiment additionally defines that the server device 2 performs such a process. Note that the server device 2 of the second embodiment also stores the fixed text used in such an email in the mass storage system 2g. In addition, the monitoring person K1 who has received the email including the instruction issues an instruction to immediately go to the house of the monitored person and check the condition of the monitored person (user), for example, by making a phone call to the watching person K11 or K12.

As described above, in the second embodiment, the screen of the received television broadcast and the first question screen 21 are sequentially switched between repeatedly on the display screen 10a of the television device 10 if an answer to the first question is not acquired from the user. If the number of times of repetition has exceeded the number-of-times threshold, the server device 2 is notified that “an unusual situation has occurred to the user”. By performing such a process, an opportunity to answer the first question can be presented to the user a plurality of times to prompt the user to input the answer. In addition, in the case where the user is so ill that the user cannot input the answer, the server device 2 can grasp that an unusual situation has occurred to the monitored person based on the counted number of times of repetition. Thus, an action such as sending the watching person can be taken immediately in the event of an unusual situation.

The communication terminal device 30 ends the process after transmitting a notification indicating that an unusual situation has occurred to the user (S64); however, in a modification of the second embodiment, the process may return to step S5 of the first flowchart of FIG. 15 so that the first question screen 21 is repeatedly displayed on the television device 10 until an answer is acquired from the user. However, it is preferable to configure the process to return to step S5 without transmission of a “notification indicating that an unusual situation has occurred to the user” to the server device 2 when the process reaches step S64 of the fifth flowchart thereafter, in the case where the first question screen 21 is re-displayed even after the current count has exceeded the number-of-times threshold (S62: YES), so as to prevent the notification from being transmitted to the server device 2 again and again unnecessarily.

If the communication terminal device 30 acquires information indicating there has been an answer from the user when the first question screen 21 is repeatedly displayed in the above-described modification, the communication terminal device 30 may output, to the television device 10, question screen information corresponding to a third question screen different from the first question screen 21 and the second question screen 26. An example of a question contained in the third question screen may be “You haven't answered the question for a long time. Is anything wrong with you?”. Options for the answer to such a question may be “1 Yes (Contact me)”, “2 No (Has been away with TV on)”, “3 No (Something was wrong but got better)”, and “4 No: Answered by others (user is OK)”. The user selects one of these answer options by operating the corresponding numerical key 19i (see FIG. 4) of the remote control 19.

In another modification, two thresholds, i.e., a first number-of-times threshold and a second number-of-times threshold, may be prepared as the number-of-times threshold used in step S62 of the fifth flowchart. The process illustrated in the fifth flowchart may be initially performed using the first number-of-times threshold. If the current count exceeds the first number-of-times threshold in step S62 (S62: YES), the process may return to, instead of proceeding to step S64, S5 of the first flowchart in which the communication terminal device 30 may output, to the television device 10, question screen information corresponding to the first question screen 21 additionally including a message “An email will be sent to the watching person unless you answer the question” so as to present the first question screen 21 additionally including the message to the user. After outputting the first question screen 21 additionally including the message, the process proceeds to the fifth flowchart after steps S5 to S9 of the first flowchart. At that time, the second number-of-times threshold is used in step S62.

If the number of times of repetition exceeds the second number-of-times threshold in step S62 in which the second number-of-times threshold is used (S62: YES), the process proceeds to step S64, in which a notification indicating that “an unusual situation has occurred to the user” is transmitted to the server device 2. In such a modification, a notification about an unusual situation is not immediately transmitted to the server device 2 when an answer is not acquired from the user but a notification indicating that “an unusual situation has occurred to the user” is transmitted to the server device 2 if an answer is not acquired even after the first question screen additionally including the message is displayed a plurality of times. Thus, a notification of an unusual situation can be made more carefully.

Further, as for the above-described modification using the first number-of-times threshold and the second number-of-times threshold, yet another modification may occur. The value of the time threshold used in step S8 of the first flowchart and the value of the certain period used in step S63 of the fifth flowchart may be changed each time after the count exceeds the number-of-times threshold before the count exceeds the second number-of-times threshold. In this case, if a correct answer from the user is expected, it is preferable that the time threshold is changed to be longer than the default value and the certain period is changed to be shorter than the default value, so that the answer for the first question is displayed as long as possible. In addition, in the case where waiting for a user's answer is prioritized, it is preferable that the time threshold is kept substantially at the default value and the certain period is changed to be longer than the default value. Note that as for contents other than the ones described above, the second embodiment is the same as the first embodiment, and the above-described various modifications of the first embodiment can also be applied to the second embodiment.

### Third Embodiment

FIG. 23 is a sixth flowchart according to a third embodiment of the present invention. This sixth flowchart illustrates a processing procedure alternatively used in steps subsequent to step S24: YES of the second flowchart of FIG. 16. The third embodiment is characterized in that content based on proper screen information of the communication terminal device 30 is displayed instead of the screen of the received television broadcast in response to an operation of pressing the end button on the local government home screen 23 of FIG. 7(a). The basic hardware configuration or the like of the third embodiment is similar to that of the first embodiment. Thus, the third embodiment will be described below by using the same reference signs as those used in the first embodiment for the similar parts.

The communication terminal device 30 according to the third embodiment is not a device specific to the watch-over service but has functions of a general set-top box or functions of a smartphone. Accordingly, the communication terminal device 30 is capable of presenting proper screens, such as a home screen including icons for starting various functions and a function screen based on a function corresponding to an icon selected on the home screen. The communication terminal device 30 is capable of outputting proper screen information corresponding to each proper screen to the television device 10 and displaying various proper screens on the display screen 10a of the television device 10.

Because the communication terminal device 30 has such functions, the communication terminal device 30 includes an operating-system-related process such as the above-described home screen in the system program P1 and has applications (application programs) for the other application-based functions stored (installed) in the memory 35. Examples of the application-based functions include a function for executing VOD (Video On Demand). When this VOD function is started, the communication terminal device 30 is capable of accessing an external VOD server to obtain content provided by the VOD server and displaying the content on the display screen 10a of the television device 10.

The sixth flowchart of FIG. 23 illustrates a process related to the above-described example, i.e., the VOD function. In the case where an operation of pressing the end button is performed on the local government home screen 23 of FIG. 7(a) in step S24 of the second flowchart of FIG. 16 (S24: YES), the communication terminal device 30 starts, instead of proceeding to step S25, the process of the sixth flowchart, and outputs screen information corresponding to the home screen to the television device 10 (S70). As a result of this output, the home screen is displayed on the display screen 10a of the television device 10, and the user (the monitored person) is allowed to select a desired icon from among a plurality of icons arranged on the home screen. It is assumed that the plurality of icons include an icon for the VOD function. In addition, since the input line of the television device 10 is set to the first external connection unit 17a to which the communication terminal device 30 is connected in step S24, it is not necessary to switch the input line in order to display the home screen. Accordingly, in this step (S70), the communication terminal device 30 does not output the input line switching instruction to the television device 10.

The communication terminal device 30 determines whether information indicating selection of an icon corresponding to the VOD function is acquired from the television device 10 (S71). If information indicating selection of the icon corresponding to the VOD function is not acquired (S71: NO), the communication terminal device 30 enters a state for waiting for the user to select the icon. If information indicating selection of the icon corresponding to the VOD function is acquired (S71: YES), the communication terminal device 30 accesses the VOD server and transmits a VOD request (S72).

Upon receipt of the VOD request, the VOD server transmits screen information corresponding to a VOD home screen to the communication terminal device 30 (S73). Note that the VOD home screen allows the user to select content, such as video, which the user wishes to watch. Upon receipt of the screen information corresponding to the VOD home screen, the communication terminal device 30 outputs the received screen information to the television device 10 (S74). The communication terminal device 30 then determines whether information indicating selection of content is acquired from the television device 10 (S75). If information indicating selection of content is not acquired (S75: NO), the communication terminal device 30 enters a state for waiting for the user to select content.

If information indicating selection of content is acquired (S75: YES), the communication terminal device 30 accesses the VOD server and transmits a request for the selected content (S76). Upon receipt of the request for the content, the VOD server transmits data (content data) corresponding to the requested content to the communication terminal device 30 (S77). Upon receipt of the content data, the communication terminal device 30 outputs the received content data to the television device 10 (S78). Consequently, the content, such as video, desired by the user is displayed on the display screen 10a of the television device 10, and the user can enjoy various kinds of content as well as a television broadcast. After step S78, the communication terminal device 30 performs processing of step 26 and subsequent steps of the second flowchart of FIG. 16. The VOD server, on the other hand, ends the process related to this content request.

In addition, in the case where the communication terminal device 30 is notified of a second-or-subsequent power-on operation of the day, the process proceeds to step S70 of the sixth flowchart of FIG. 23 from “C” subsequent to step S3 of the first flowchart of FIG. 15. In this way, the user can enjoy the VOD function by using the communication terminal device 30. Note that the VOD function has been described by way of example above; however, obviously, screens of various functions that can be provided by the communication terminal device 30 based on the applications (application programs) can be output to the television device 10 and displayed on the display screen 10a in addition to the VOD function. Note that as for contents other than the ones described above, the third embodiment is the same as the first embodiment, and the above-described various modifications of the first embodiment can also be applied to the third embodiment.

### Fourth Embodiment

FIG. 24 illustrates a pop-up screen 61 which is an example of antecedent information output to the television device 10 from the communication terminal device 30 of the user condition checking system according to a fourth embodiment of the present invention. The fourth embodiment of the present invention is characterized in that the pop-up screen 61 is displayed/output prior to the first question screen 21 illustrated in FIG. 6(a). In this way, the condition of the user (especially, whether the user is alive) can be checked immediately. The system configuration and hardware configuration of the fourth embodiment are similar to those of the first embodiment described above. Thus, the fourth embodiment will be described below by using the same reference signs as those used in the first embodiment for the similar parts.

To display the pop-up screen 61 illustrated in FIG. 24 on the display screen 10a, the communication terminal device 30 according to the fourth embodiment stores display part data (pop-up data) used to display the pop-up screen 61 in the watch-over-service display table T2 stored in the memory 35. As illustrated in FIG. 24, the pop-up screen 61 includes a text part 61a and a selectable button 61b. Thus, the pop-up data (corresponding to the antecedent information) of the pop-up screen 61 includes data used to display the text part 61a in combination with drawing data of the button 61b and the background part.

As in the first question screen 21 of FIG. 6(a), the user name (or the nickname) or the like included in the user information D4 is read from the memory 35 and is pasted at the part “Mr. XX” included in the text part 61a. A phrase appropriate for the time slot is pasted instead of the phrase “this morning” included in the text part 61a. Phrases such as “now”, “this afternoon”, and “this evening” are also included in the watch-over-service display table T2. In addition, the pop-up screen 61 includes the button 61b, thereby indicating that a user operation can be performed on this pop-up screen 61.

The memory 35 of the communication terminal device 30 stores the watch-over program P2 of the fourth embodiment in order to display the above-described pop-up screen 61. The memory 35 also stores information such as a time reference and a number-of-times reference in order to control the period for which and the number of times at which the pop-up screen 61 is displayed.

The time reference corresponds to a value set for a period for which the pop-up screen 61 is displayed. For example, a period of 30 seconds is set; however, just like the time threshold D5 described in the first embodiment, the time reference can be set to a desired value in a range from 5 seconds to 3 minutes through a setup menu not illustrated. The number-of-times reference corresponds to a value set for the number of times up to which the pop-up screen 61 is displayed. For example, a value of 5 times is set; however, like the time reference, the number-of-times reference can be set to a desired value in a range from once to 15 times. In the case where quickly checking the condition of the user by the server device 2 or the like is desired, it is preferable to set the time reference to a value of 30 seconds or shorter (a range from 10 seconds to 20 seconds is preferable) and the number-of-times reference to a value of 4 times or less. In the case where the operability of a button 51b is prioritized, it is preferable to set the time reference to a value of 30 seconds or longer (a range from 40 second to 50 seconds is preferable) and the number-of-times reference to a value of 5 times or more.

The watch-over program P1 of the fourth embodiment additionally implements a process of displaying the pop-up screen 61 in addition to the processes described in the first embodiment. Specifically, in the first embodiment, the watch-over program P2 defines that the CPU 31 performs a process of transmitting the first power-on information to the server device 2 and then performs a process of outputting the screen information corresponding to the first question screen 21 to the television device 10, in the case where the communication terminal device 30 acquires a power-on operation for the first time on the day from the television device 10. In contrast, in the fourth embodiment, the watch-over program P2 defines that the CPU 31 performs a process of transmitting the first power-on information to the server device 2 and then performs a process of reading the pop-up data of the pop-up screen 61 from the memory 35 and outputting the read pop-up data to the television device 10.

Note that reading of such pop-up data and outputting of the pop-up screen 61 are performed indirectly in response to a first power-on operation of the day. As a result of the output of this pop-up data, the pop-up screen 61 is displayed on the broadcast video image that is being displayed so as to come up from the lower right part of the display screen 10a of the television device 10. In addition, the pop-up data is displayed so as to be superimposed on the television broadcasting video image that is being displayed on the television device 10. Thus, the communication terminal device 30 does not output an input line switching instruction (display switching instruction).

The watch-over program P2 defines that the CPU 31 performs, after outputting the pop-up data, a process of measuring a period elapsed from the output and of determining (detecting) whether information indicating that the user has performed an operation of pressing the OK button 19g (corresponding to operation accepting means) of the remote control 19 (user interface unit) as indicated by the button 61b of the pop-up screen 61 is acquired. The operation of pressing the OK button 19g of the remote control 19 performed by the user in response to display of the pop-up screen 61 on the display screen 10a corresponds to a user's response operation on the antecedent information. Such a response operation is accepted by the OK button 19g of the remote control 19.

The watch-over program P2 defines that, upon the CPU 31 detecting acquisition of information indicating that there has been an operation of pressing the OK button 19g, the CPU 31 performs a process of transmitting a “notification indicating that there has been a user operation” to the server device 2 together with the device identification information D1 and the user ID to perform control. Transmission of such a notification allows the server device 2 to grasp that the user is alive at an early phase without waiting for a user's answer to the first question screen 21 unlike in the first embodiment, and consequently the person in charge of monitoring (the monitoring person K1 of the local government A) can advantageously immediately confirm that the user is alive. Note that the watch-over program P2 defines that, in the case of acquisition of the information indicating that the user has performed an operation of pressing the OK button 19g, the CPU 31 performs the process of outputting screen information corresponding to the first question screen 21 and the subsequent processes described in the first embodiment.

The watch-over program P2 defines that, in the case where the CPU 31 determines (detects) that the information indicating that there has been an operation of pressing the OK button 19g is not acquired, the CPU 31 performs a process of determining whether the measured period has exceeded the time reference by comparing the measured period with the time reference stored in the memory 35. The watch-over program P2 defines that the CPU 31 enters a state for waiting to acquire information indicating that there has been an operation of pressing the OK button 19g if the measured period has not exceeded the time reference and that CPU 31 performs a process of transmitting a “notification indicating that there is no user operation” to the server device 2 together with the device identification information D1 and the user ID so as to perform control, upon the measured period exceeding the time reference. Transmission of such a notification allows the server device 2 to grasp that an unusual situation might have occurred to the user at an early phase, and consequently the person in charge of monitoring (the monitoring person K1 of the local government A) can advantageously smoothly get ready for an unusual situation of the user.

The CPU 31 defines that, after transmitting the “notification indicating that there is no user operation”, output of the pop-up screen 61 is temporarily stopped, the number of times the pop-up screen is output is incremented by one, is stored in the memory 35, and is compared with the number-of-times reference stored in the memory 35. The watch-over program P2 defines that if the count does not exceed the number-of-times reference, the pop-up screen 61 is output again after a certain period (e.g., 5 seconds) has elapsed, and then the control unit 14 repeats the above-described process thereafter. Note that the value of the certain period is also stored in the memory 35. The value of the period is appropriately set in a range from 1 second to 3 minutes and is stored, just like the reference time.

The watch-over program P2 defines that, in the case where information indicating that the user has performed an operation of pressing the OK button 19g has not acquired even after re-outputting of the pop-up data of the pop-up screen 61 and transmission of the “notification indicating that there is no user operation” are repeated and the count has exceeded the number-of-times reference, the CPU 31 performs a process of transmitting a “notification indicating that an unusual situation has occurred to the user” to the server device 2 together with the device identification information D1 and the user ID. In the case where information indicating that the user has performed an operation of pressing the OK button 10g is not acquired even after the pop-up screen 61 is displayed repeatedly, the user might be so ill that the user cannot operate the OK button 19g of the remote control 19. Thus, the above-described “notification indicating that an unusual situation has occurred to the user” is made. In addition, transmission of such a notification allows the server device 2 to grasp that the user is in a serious condition at an early phase, and consequently the person responsible for monitoring (the monitoring person K1 of the local government A) can also advantageously immediately take an action against the user who is in a serious condition. Other than the content described, the communication terminal device 30 of the fourth embodiment performs processes similar to those of the first embodiment.

The communication terminal device 30 transmits the “notification indicating that there has been a user operation”, the “notification indicating that there is no user operation”, or the “notification indicating that an unusual situation has occurred to the user” to the server device 2 of the fourth embodiment as described above. Thus, the server device 2 determines whether any of these transmitted notifications has been received. If any of the notifications is received, the server device 2 stores, for each user, the notification together with the reception date-and-time in the answer DB 6 stored in the mass storage system 2g (see FIG. 8). A process related to such storage is additionally defined by the watch-over service program 4 of the fourth embodiment. In addition, like the content of the answer in the first embodiment, the server device 2 distributes the condition list screen or the detail screen containing such a transmitted notification. Such a process is also additionally defined by the watch-over service program 4 of the second embodiment.

The watch-over service program 4 of the fourth embodiment additionally defines that, upon receipt of the “notification indicating that an unusual situation has occurred to the user”, the server device 2 also performs a process of receiving the device identification information D1 and the user ID that are transmitted from the communication terminal device 30 together with the notification, identifying an email address corresponding to the terminal device A1 used by the monitoring person K1 associated with the received user ID in accordance with the user DB, and automatically creating and transmitting an email including an instruction (fixed text) to immediately go and check on the monitored person to the identified email address. Note that the server device 2 of the fourth embodiment also stores the fixed text used in such an email in the mass storage system 2g. Upon receipt of the email including such an instruction, the monitoring person K1 issues, for example, by making a phone call to the watching person K11 or K12, an instruction to immediately go to the house of the monitored person and check the condition of the monitored person (user).

FIG. 25 is a seventh flowchart of a procedure of the above-described processes performed by the communication terminal device 30 and the server device 2 according to the fourth embodiment. This seventh flowchart illustrates a procedure of the process of the fourth embodiment added to the first flowchart of FIG. 15 described in the first embodiment. Specifically, processing of steps S81 to S91 performed by the communication terminal device in the seventh flowchart is added between step S4 (transmission of first power-on information) and step S5 (output of screen information corresponding to the first question screen) performed by the communication terminal device in the first flowchart. Processing of steps S100 to S106 performed by the server device in the seventh flowchart is added between YES of step S12 (first power-on information?: YES) and step S13 (storage of the first state information) performed by the server device in the first flowchart.

The procedure of the processes collaboratively performed by the communication terminal device 30 and the server device 2 according to the fourth embodiment will be described with reference to this seventh flowchart. First, after transmitting the first power-on information (S4), the communication terminal device 30 reads the pop-up data of the pop-up screen 61 from the watch-over-service display table T2 stored in the memory 35 (S81) and outputs the pop-up data to the television device 10 (S82). As a result of output of this pop-up data, the pop-up screen 61 is displayed on the television device 10 as illustrated in FIG. 24(a). The pop-up screen 61 is displayed at a part of the display screen 10a of the television device 10. Thus, the communication terminal device 30 does not output a display switching instruction to switch the input line. In addition, the communication terminal device 30 starts measuring an elapsed period after outputting the pop-up data.

Then, the communication terminal device 30 determines whether information indicating that there has been a user operation (an operation of pressing the OK button 19g of the remote control 19) for the button 61b of the pop-up screen 61 is acquired (S83). If the information indicating that there has been a user operation is acquired (S83: YES), the communication terminal device 30 transmits a notification indicating that there has been a user operation to the server device 2 (S84). After the communication terminal device 30 has transmitted the notification indicating that there has been a user operation, the process proceeds to step S5 of the first flowchart of FIG. 15, in which the communication terminal device 30 outputs the screen information corresponding to the first question screen 21 of FIG. 6(a).

In response to the above-described process performed by the communication terminal device 30, the server device 2 determines whether the notification indicating that there has been a user operation is received (S100). If the notification is received (S100: YES), the server device 2 stores, for the corresponding user, the received notification indicating that there has been a user operation in the answer DB 6 of the mass storage system 2g (see FIG. 9) together with the reception date-and-time (S101). If the notification is not received (S100: NO), the server device 2 does not perform any particular processing, and the process proceeds to the next step.

Referring back to the process performed by the communication terminal device 30, if the information indicating that there has been a user operation is not acquired (S83: NO), the communication terminal device 30 determines whether the measured period has exceeded the time reference (S85). If the measured period has not exceeded the time reference (S85: NO), the process returns to step (S83) of determining whether the information indicating that there has been a user operation is acquired, and the communication terminal device 30 enters a state for waiting to acquire the information indicating that there has been a user operation until the measured period exceeds the time reference.

If the measured period has exceeded the time reference (S85: YES), the communication terminal device 30 transmits a notification indicating that there is no user operation to the server device 2 (S86). In response to transmission of such a notification, the server device 2 determines whether the notification indicating that there is no user operation is received (S102). If the notification is received (S102: YES), the server device 2 stores, for the corresponding user, the received notification indicating that there is no user operation in the answer DB 6 of the mass storage system 2g (see FIG. 9) together with the reception date-and-time (S103). If the notification is not received (S102: NO), the server device 2 does not perform any particular processing, and the process proceeds to the next step.

Referring back to the process performed by the communication terminal device 30, the communication terminal device 30 temporarily stops output of the pop-up data (S87) and, in response to that, stops measuring the period and resets the measured period. Then, the communication terminal device 30 increments the number of times the pop-up data is output (count) by 1 and stores the current count in the memory 35 (S88). Then, the communication terminal device 30 determines whether the current count has exceeded the number-of-times reference (S89). If it is determined that the current count has not exceeded the number-of-times reference (S89: NO), the communication terminal device 30 counts a certain period (e.g., 5 seconds) (S90), and then the process returns to step (S82) of outputting the pop-up data. In this way, the pop-up data is output again and the pop-up screen 61 is displayed again to be superimposed on the television broadcasting video image on the display screen 10a of the television device 10.

After re-outputting the pop-up data, the communication terminal device 30 repeats the process of transmitting the above-described notification indicating that there is no user operation (S86), stopping outputting the pop-up data (S87), and re-outputting the pop-up data if there is no user operation thereafter and the count does not exceed the number-of-times reference.

On the other hand, if the current count has exceeded the number-of-times reference (S89: YES), the communication terminal device 30 transmits the “notification indicating that an unusual situation has occurred to the user” to the server device 2 (S91). After the communication terminal device 30 has transmitted the “notification indicating that an unusual situation has occurred to the user”, the process performed by the communication terminal device 30 temporarily ends.

In response to transmission of the above-described “notification indicating that an unusual situation has occurred to the user” from the communication terminal device 30, the server device 2 determines whether the “notification indicating an unusual situation has occurred to the user” is received (S104). If the notification is received (S104: YES), the server device 2 performs a process of identifying an email address of the monitoring person associated with the user ID or the like transmitted together with the notification (S105) and automatically creating and transmitting an email including an instruction to immediately go and check on the monitored person to the identified email address (S106). At that point, the process of this time ends. Note that if the server device 2 does not receive the “notification indicating that an unusual situation has occurred to the user” (S104: NO), the process proceeds to step S13 of the first flowchart of FIG. 15.

As described above, in the user condition checking system of the fourth embedment, the first question screen 21 illustrated in FIG. 6(a) is not displayed directly in response to a power-on operation on the television device 10 but the pop-up screen 61 illustrated in FIGS. 24(a) and (b) is displayed prior to the first question screen 21. Thus, if the monitored person performs an operation of pressing the OK button 19g of the remote control 19 in response to this pop-up screen 61, the process can proceed to the next step. Accordingly, the system can provide the monitored person (user) with an opportunity of performing an operation right away without answering a question such as on the first question screen 21 (without giving a thought), thereby being able to immediately check the condition of the user based on whether there is a user operation.

Note that the fourth embodiment of the present invention is not limited to the content described above, and various modifications may occur. For example, as for the method of displaying/outputting the pop-up screen 61, the pop-up screen 61 may appear from a portion of the display screen 10a other than the lower right portion of the display device 10a so as to go up therefrom. In order to draw an attention of the user (monitored person), the pop-up screen 61 may be displayed so as to blink or the displayed pop-up screen 61 may move within the display screen 10a. Further, in order make the user watch the pop-up screen 61 for sure, it is effective to increase the size of the pop-up screen 61 so as to make the broadcast video image 50 on which the pop-up screen 61 is superimposed less visible. The pop-up screen 61 can be increased up to a size so that it is displayed on the entire screen of the display screen 10a. In the case of full screen display, it is preferable that the communication terminal device 30 outputs, to the television device 10, an instruction to switch the input line (to the first external connection unit 17a) so as to display the pop-up screen on the entire screen of the television device 10.

In addition, as for the text content of the text part 61a of the pop-up screen 61, content that prompts or instructs a user to perform an action such as “Please press this button” or quiz-like content asking “What are your stars today?” may be used in addition to the above-described question-like content. It is important to make the text have content that prompts the user to perform an operation so as to be able to check whether the user (monitored person) is alive.

Further, in the above description, the process of temporarily stopping displaying the pop-up screen 61 and then re-displaying the pop-up screen 61 is repeated if there is no user operation while the pop-up screen 61 is displayed for a certain period; however, the pop-up screen 61 may be kept displayed obviously.

FIG. 26 is an eighth flowchart illustrating a procedure of a process according to a modification of the fourth embodiment and illustrating the flow of a process performed in the case where the pop-up screen 61 is kept displayed. In this modification, the above-described time reference is a maximum period for which the pop-up display 61 is kept displayed. Thus, the value set as the time reference is longer than that set in the above-described case. It is preferable to set the value in a range from 1 minute to 5 minutes, for example. In addition, because the pop-up screen 61 is not displayed repeatedly in this modification, setting and processing regarding the number-of-times reference are not needed.

In the eighth flowchart according to the modification illustrated in FIG. 26, the communication terminal device 30 first performs processing of steps S111 to S113. In addition, if the communication terminal device 30 acquires information indicating that there has been a user operation for the displayed pop-up screen (S113: YES), the communication terminal device 30 transmits a notification indicating that there has been a user operation to the server device 2 (S114) as in the seventh flowchart. In response to transmission of this notification, the server device 2 also performs processing (S120 and S121) similar to that of the seventh flowchart described above.

On the other hand, if there is no user operation (S113: NO), the communication terminal device 30 determines whether a period from the output of the pop-up data (measured period) has exceeded the time reference (S115). If the measured period has not exceeded the time reference (S115: NO), the process returns to step (S113) of determining whether information indicating that there has been a user operation is acquired, and the communication terminal device 30 enters a state for waiting to acquire the information indicating that there has been a user operation until the measured period exceeds the time reference. Note that the pop-up screen 61 is kept displayed in this waiting state. If the measured period has exceeded the time reference (S115: YES), the communication terminal device 30 immediately transmits a “notification indicating that an unusual situation has occurred the user” to the server device 2 (S116), and the process performed by the communication terminal device 30 temporarily ends. In response to transmission of this notification, the server device 2 also performs processing (S122 to S124) similar to that of the seventh flowchart described above.

As described above, in the modification illustrated in FIG. 26, processing related to transmission of the “notification indicating that there is no user operation” is omitted from the processing illustrated in FIG. 25. Thus, the series of processing is advantageously simplified. In addition, by keeping displaying the pop-up screen 61, the user (monitored person) can be provided with an opportunity of performing an operation anytime, which is preferable.

In step S91 of the seventh flowchart and step S116 of the eighth flowchart described above, the process performed by the communication terminal device 30 is temporarily ended after transmission of the “notification indicating that an unusual situation has occurred to the user”, to the server device 2; however, contents similar to the various modifications described in the second embodiment above can be applied to the fourth embodiment. For example, after the communication terminal device 30 transmits the notification indicating that an unusual situation has occurred to the user to the server device 2 in step S91 or step 116, the process may return to step (S82 or S112) of outputting the pop-up data so as to keep displaying the pop-up screen 61 on the television device 10 until a user operation is performed. In this case, however, the notification indicating that an unusual situation has occurred is transmitted to the server device 2 every time the count exceeds the number-of-times reference (S89: YES) or the measured period exceeds the time reference (S115: YES). Thus, in order to avoid such transmission, it is preferable to make the process return to step S82 or S112 without transmitting the notification indicating that an unusual situation has occurred even if the process proceeds to step S91 or S116 thereafter in the case of re-displaying the pop-up screen 61.

In addition, in the case where the communication terminal device 30 acquires information indicating that there has been a user operation when the pop-up screen 61 is kept displayed in the above-described modification, the communication terminal device 30 may output, to the television device 10, question screen information corresponding to a third question screen different from the first question screen 21 and the second question screen 26. An example of a question included in the third question screen may be “You haven't answered the question for a long time. Is anything wrong with you?”. Options for the answer to such a question may be “1 Yes (Contact me)”, “2 No (Has been away with TV on)”, “3 No (Something was wrong but got better)”, and “4 No: Answered by others (user is OK)”. The user selects one of these answer options by operating the corresponding numerical key 19i (see FIG. 4) of the remote control 19.

In yet another modification, two number-of-times references such a first number-of-times reference and a second number-of-times reference may be prepared as the number-of-times reference used in step S89 of the seventh flowchart. The process illustrated in the seventh flowchart is initially performed by using the first number-of-times reference. If the current count has exceeded the first number-of-times reference in step S89 for the first time (S89: YES), the process returns to step S82, in which the communication terminal device 30 may output, to the television device 10, pop-up data additionally including text “An email will be sent to the watching person unless you answer the question”, and a pop-up screen additionally including such text may be presented to the user. After the pop-up data additionally including the text has been output, the process proceeds to step S89 from step S82. In step S89, the second number-of-times reference is used at this time.

If the repetition count has exceeded the second number-of-times reference in step S89 in which the second number-of-times reference is used (S89: YES), the process proceeds to step S91, in which “information indicating that an unusual situation has occurred to the user” may be transmitted to the server device 2. In such a modification, the “information indicating that an unusual situation has occurred” is transmitted to the server device 2 if there is no answering operation after the pop-up screen including the text has been displayed multiple times, instead of immediately transmitting the information to the server device 2 if there is no answering operation from the user. Thus, notification of an unusual situation can be made carefully.

Further, there is a further modification for the above-described modification using the first number-of-times reference and the second number-of-times reference. The time reference used in step S85 of the seventh flowchart and the certain period used in step S90 may be changed each time after the current count has exceeded the first number-of-times reference before the current count exceeds the second number-of-times reference. In this case, if a correct answer from the user is expected, it is preferable that the time reference is changed to be longer than the default value and the certain period is changed to be shorter than the default value, so that the pop-up screen is displayed for a period as long as possible. In addition, in the case where waiting for a user's answer is prioritized, it is preferable that the time reference is kept substantially at the default value and the certain period is changed to be longer than the default value.

In addition, in the fourth embodiment, the form of the antecedent information that is output prior to the first question screen 21 illustrated in FIG. 6(a) is not limited to the pop-up screen 61 described above, and various forms can be employed as long as they are types of output perceivable by the user (human). For example, an icon or a window other than the pop-up screen may be displayed if they are visually perceivable, and these display outputs may be combined with an audio output and the combination may be used as the antecedent information.

Further, audio content alone may be used as the antecedent information. In this case, the content of the text part 61a of the above-described pop-up screen 61 is output to the television device 10 as the audio antecedent information. How to perform an operation is also output by audio so as to provide the user with information indicating that the user can perform a response operation. In this way, the television device 10 outputs the content “Mr. XX, how do you feel this morning? Please press the OK button of the remote control.” from the speakers 10b.

In the description above, the antecedent information (pop-up data) is stored in the memory 35 of the communication terminal device 30; however, the antecedent information may be stored in the server device 2 or part of the antecedent information may be stored in the server device 2 and the rest may be stored in the communication terminal device 30, just like the question screen information corresponding to the first question screen 21 illustrated in FIG. 6(a).

In the case of storing the antecedent information (pop-up data) in the server device 2, in response to YES in step S12 of the first flowchart illustrated in FIG. 15 (in response to receipt of the first power-on information of the day), the server device 2 reads the stored antecedent information (pop-up data) and transmits the antecedent information to the communication terminal device 30. The communication terminal device 30 outputs the antecedent information that has been transmitted thereto to the television device 10.

In addition, in the case of storing part of the antecedent information (pop-up data) in the server device 2 and storing the rest in the communication terminal device 30, in response to YES in step S12 of the first flowchart illustrated in FIG. 15 (in response to receipt of the first power-on information of the day), the server device 2 reads the stored part of the antecedent information (pop-up data) and transmits the part of the antecedent information to the communication terminal device 30. Upon receipt of the part of the antecedent information, the communication terminal device 30 reads the rest of the antecedent information stored in the memory 35, generates complete antecedent information by combining the received part of the antecedent information with the rest thereof, and outputs the generated antecedent information to the television device 10. Note that as for contents other than the ones described above, the fourth embodiment is similar to the first embodiment, and the above-described various modifications of the first embodiment can also be applied to the fourth embodiment.

### INDUSTRIAL APPLICABILITY

The present invention is suitably used in the case where a question or the like is presented to a monitored person by using a display function of a display device (e.g., the television device 10) operated by the user and a question answering state is transmitted to the server device 2 via the communication terminal device 30 connected to the display device, thereby allowing the server device 2 to immediately grasp details about the condition of the monitored person without providing various sensors.

### REFERENCE SIGNS LIST

1 user condition checking system

2 server device

4 watch-over service program

5 user DB

6 answer DB

7 second question DB

10 television device

17a first external connection unit

19 remote control

30 communication terminal device

P2 watch-over program

K1 monitoring person

A1 communication terminal

K11, K12 watching person

A11, A12 mobile communication terminal

M1 monitored person

H1 house

NW network

1-22. (canceled)

23. A user condition checking system enabling a server device to remotely check a condition of a user by causing a communication terminal device including a connection unit that is connectable to an external display device operated by the user to transmit, to the server device from a communication unit, information based on a state of a user operation on the external display device,
the communication terminal device including:
means for performing a process of transmitting, to the server device from the communication unit, power-on information indicating that there has been a power-on operation, in a case where information indicating that there has been a power-on operation is acquired from the external display device by the connection unit;
means for performing a process of outputting, to the external display device from the connection unit, question screen information containing a question that can be answered by a selection operation, in response to the acquisition of the information indicating that there has been a power-on operation; and
means for performing a process of transmitting, to the server device from the communication unit, answering state information indicating a question answering state of the user, and
the server device including:
means for performing a process of storing the power-on information in association with a reception date-and-time of the power-on information in a case of receipt of the power-on information; and
means for performing a process of storing the answering state information in association with a reception date-and-time of the answering state information in a case of receipt of the answering state information.

24. The user condition checking system according to claim 23, wherein the server device further includes:
means for determining whether the power-on information transmitted from the communication terminal device is power-on information that is transmitted for the first time on a day; and
means for performing a process of transmitting, to the communication terminal device, a determination result indicating a result of the determination in a case where it is determined that the power-on information is power-on information that is transmitted for the first time on the day, and
wherein the communication terminal device
is configured to output, to the external display device from the connection unit, the question screen information in a case where the determination result is received from the server device by the communication unit in response to the transmission of the power-on information performed upon the acquisition of the information indicating that there has been a power-on operation.

25. A user condition checking method enabling a server device to remotely check a condition of a user by causing a communication terminal device including a connection unit that is connectable to an external display device operated by the user to transmit, to the server device from a communication unit, information based on a state of a user operation on the external display device, the user condition checking method comprising:
a step of performing, by the communication terminal device, a process of transmitting, to the server device from the communication unit, power-on information indicating that there has been a power-on operation, in a case where information indicating that there has been a power-on operation is acquired from the external display device by the connection unit;
a step of performing, by the communication terminal device, a process of outputting, to the external display device from the connection unit, question screen information containing a question that can be answered by a selection operation, in response to the acquisition of the information indicating that there has been a power-on operation;
a step of performing, by the communication terminal device, a process of transmitting, to the server device from the communication unit, answering state information indicating a question answering state of the user;
a step of performing, by the server device, a process of storing the power-on information in association with a reception date-and-time of the power-on information in a case of receipt of the power-on information; and
a step of performing, by the server device, a process of storing the answering state information in association with a reception date-and-time of the answering state information in a case of receipt of the answering state information.

26. A communication terminal device that is connectable, via a connection unit, to an external display device operated by a user and that transmits, to an external server device from a communication unit, information based on a state of a user operation on the external display device,
the communication terminal device comprising:
means for performing a process of transmitting, to the external server device from the communication unit, power-on information indicating that there has been a power-on operation, in a case where information indicating that there has been a power-on operation is acquired from the external display device by the connection unit;
means for performing a process of outputting, to the external display device from the connection unit, question screen information containing a question that can be answered by a selection operation, in response to the acquisition of the information indicating that there has been a power-on operation; and
means for performing a process of transmitting, to the external server device from the communication unit, answering state information indicating a question answering state of the user.

27. The communication terminal device according to claim 26, wherein the external display device is a television device, and
wherein the communication terminal device further comprises:
means for performing a process of outputting, to the external display device from the connection unit, screen information that permits an end operation, in a case where an answer to the question is acquired from the external display device by the connection unit; and
means for performing a process of outputting, to the external display device from the connection unit, a display switching instruction so as to cause a displayed screen to be switched to a screen of a received television broadcast, in a case where information indicating that there has been an end operation is acquired from the external display device by the connection unit.

28. The communication terminal device according to claim 26, further comprising:
means for performing a process of outputting, to the external display device from the connection unit, screen information that permits an end operation, in a case where an answer to the question is acquired from the external display device by the connection unit; and
means for performing a process of outputting, to the external display device from the connection unit, proper screen information containing content uniquely provided by the communication terminal device, in a case where information indicating that there has been an end operation is acquired from the external display device by the connection unit.

29. The communication terminal device according to claim 26, further comprising means for performing a process of outputting, to the external display device from the connection unit, antecedent information that permits a user operation prior to the question screen information, in a case where the information indicating that there has been a power-on operation is acquired from the external display device by the connection unit,
wherein the communication terminal device is configured to perform a process of outputting the question screen information to the external display device from the connection unit in a case where information indicating that there has been a user operation on the antecedent information is acquired from the external display device by the connection unit.

30. The communication terminal device according to claim 27, further comprising means for performing a process of outputting, to the external display device from the connection unit, antecedent information that permits a user operation prior to the question screen information, in a case where the information indicating that there has been a power-on operation is acquired from the external display device by the connection unit,
wherein the communication terminal device is configured to perform a process of outputting the question screen information to the external display device from the connection unit in a case where information indicating that there has been a user operation on the antecedent information is acquired from the external display device by the connection unit.

31. The communication terminal device according to claim 28, further comprising means for performing a process of outputting, to the external display device from the connection unit, antecedent information that permits a user operation prior to the question screen information, in a case where the information indicating that there has been a power-on operation is acquired from the external display device by the connection unit,
wherein the communication terminal device is configured to perform a process of outputting the question screen information to the external display device from the connection unit in a case where information indicating that there has been a user operation on the antecedent information is acquired from the external display device by the connection unit.

32. The communication terminal device according to claim 26, further comprising means for performing a process of receiving, by the communication unit, a question that is transmitted from the external server device,
wherein the communication terminal device is configured to perform a process of outputting, to the external display device from the connection unit, question screen information containing the received question in a case of receipt of the question.

33. The communication terminal device according to claim 27, further comprising means for performing a process of receiving, by the communication unit, a question that is transmitted from the external server device,
wherein the communication terminal device is configured to perform a process of outputting, to the external display device from the connection unit, question screen information containing the received question in a case of receipt of the question.

34. The communication terminal device according to claim 28, further comprising means for performing a process of receiving, by the communication unit, a question that is transmitted from the external server device,
wherein the communication terminal device is configured to perform a process of outputting, to the external display device from the connection unit, question screen information containing the received question in a case of receipt of the question.

35. The communication terminal device according to claim 29, further comprising means for performing a process of receiving, by the communication unit, a question that is transmitted from the external server device,
wherein the communication terminal device is configured to perform a process of outputting, to the external display device from the connection unit, question screen information containing the received question in a case of receipt of the question.

36. The communication terminal device according to claim 30, further comprising means for performing a process of receiving, by the communication unit, a question that is transmitted from the external server device,
wherein the communication terminal device is configured to perform a process of outputting, to the external display device from the connection unit, question screen information containing the received question in a case of receipt of the question.

37. The communication terminal device according to claim 31, further comprising means for performing a process of receiving, by the communication unit, a question that is transmitted from the external server device,
wherein the communication terminal device is configured to perform a process of outputting, to the external display device from the connection unit, question screen information containing the received question in a case of receipt of the question.

38. A computer-readable recording medium storing a computer program causing a computer, which is connectable, via a connection unit, to an external display device operated by a user and which includes a communication unit capable of communicating with an external server device, to perform a process of transmitting, to the external server device via the communication unit, information based on a state of a user operation on the external display device, the computer program causing
the computer to perform
a step of performing a process of transmitting, to the external server device by using the communication unit, power-on information indicating that there has been a power-on operation, in a case where information indicating that there has been a power-on operation is acquired from the external display device by the connection unit;
a step of performing a process of outputting, to the external display device from the connection unit, question screen information containing a question that can be answered by a selection operation, in response to the acquisition of the information indicating that there has been a power-on operation; and
a step of performing a process of transmitting, to the external server device by using the communication unit, answering state information indicating a question answering state of the user.
